(19) United States
(12) Patent Application Publication
(10) Pub. No.: US 2026/0329056 A1
(43) Pub. Date: Oct. 22, 2026

(54) OPTICAL IMAGING SYSTEM

(71) Applicant: Samsung Electro-Mechanics Co., Ltd., Suwon-si (KR)

(72) Inventors: Ji Su LEE, Suwon-si (KR); Dong Hyuk JANG, Suwon-si (KR)

(73) Assignee: Samsung Electro-Mechanics Co., Ltd., Suwon-si (KR)

(21) Appl. No.: 19/468,133

(22) Filed: Feb. 3, 2026

(30) Foreign Application Priority Data
Apr. 4, 2025 (KR) 10-2025-0044253

(51) Int. Cl. G02B 13/00; G02B 9/64

(52) U.S. Cl. CPC G02B 13/0045; G02B 9/64

(57) ABSTRACT

An optical imaging system includes a first lens having a positive refractive power; a second lens; a third lens; a fourth lens having a positive refractive power; a fifth lens; a sixth lens; a seventh lens; an eighth lens; and a ninth lens having a negative refractive power, wherein the first to ninth lenses are sequentially disposed along an optical axis from an object side of the optical imaging system toward an imaging plane, and 0.90<(TTL/(2×IMG HT))×Fno<1.00 and 1.00<f4/f<4.00 are satisfied, where TTL is a distance along the optical axis from an object-side surface of the first lens to the imaging plane, IMG HT is one half of a diagonal length of the imaging plane, Fno is an F-number, f4 is a focal length of the fourth lens, and f is a focal length of the optical imaging system.

### CROSS-REFERENCE TO RELATED APPLICATIONS

This application claims the benefit under 35 USC 119(a) of Korean Patent Application No. 10-2025-0044253 filed on Apr. 4, 2025, in the Korean Intellectual Property Office, the entire disclosure of which is incorporated herein by reference for all purposes.

### BACKGROUND

### 1. Field

The present disclosure relates to an optical imaging system.

### 2. Description of Background

Recent mobile devices may include cameras including an optical imaging system including a plurality of lenses for video calls and photos.

Also, as the functionality of cameras in a mobile device has increased, a demand for high-resolution mobile device cameras has grown.

As mobile devices have been designed to have a reduced size, a demand for slimmer mobile device cameras has also increased. Accordingly, it may be necessary to develop an optical imaging system having a reduced size and implementing a high resolution.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a positive refractive power; a second lens having a refractive power; a third lens having a refractive power; a fourth lens having a positive refractive power; a fifth lens having a refractive power; a sixth lens having a refractive power; a seventh lens having a refractive power; an eighth lens having a refractive power; and a ninth lens having a negative refractive power, wherein the first to ninth lenses are sequentially disposed in ascending numerical order along an optical axis of the optical imaging system from an object side of the optical imaging system toward an imaging plane of the optical imaging system, and 0.90<(TTL/(2×IMG HT))×Fno<1.00 and 1.00<f4/f<4.00 are satisfied, where TTL is a distance along the optical axis from an object-side surface of the first lens to the imaging plane, IMG HT is one half of a diagonal length of the imaging plane, Fno is an F-number of the optical imaging system, f4 is a focal length of the fourth lens, and f is a focal length of the optical imaging system.

Among the second lens and the third lens, a lens having negative refractive power may have a refractive index of 1.63 or more.

A combined focal length of the second lens and the third lens may have a positive value.

A combined focal length of the first lens to the third lens may have a positive value.

A conditional expression 0<f1/f<5.00 may be satisfied, where f1 is a focal length of the first lens

A conditional expression 0.80<|f2/f|<2.20 may be satisfied, where f2 is a focal length of the second lens.

A conditional expression 0.80<f12/f<1.50 may be satisfied, where f12 is a combined focal length of the first lens and the second lens.

A conditional expression 0.10<|f12/f3|<0.70 may be satisfied, where f12 is a combined focal length of the first lens and the second lens, and f3 is a focal length of the third lens.

A conditional expression 1.10<f123/f<1.70 may be satisfied, where f123 is a combined focal length of the first lens, the second lens, and the third lens.

A conditional expression −0.82<f9/f<0 may be satisfied, where f9 is a focal length of the ninth lens.

Conditional expressions 75°<FOV×(IMG HT/f)<82° and 0.55<TTL/(2×IMG HT)<0.65 may be satisfied, where FOV is a field of view of the optical imaging system.

A conditional expression 1.00<ΣCT/ΣAT<2.00 may be satisfied, where ΣCT is a sum of thicknesses along the optical axis of the first lens to the ninth lens, and ΣAT is a sum of air gaps between adjacent lenses of the first lens to the ninth lens.

A conditional expression 0.90<Td/f<1.50 may be satisfied, where Td is a distance along the optical axis from the object-side surface of the first lens to an image-side surface of the ninth lens.

A conditional expression 0.15<Yc92/f<0.50 may be satisfied, where Yc92 is a distance from the optical axis to an inflection point of an image-side surface of the ninth lens in a direction perpendicular to the optical axis.

The object-side surface of the first lens may be convex in a paraxial region thereof, and an image-side surface of the third lens may be concave in a paraxial region thereof.

An object-side surface of each of the fourth lens to the sixth lens may be convex, and an image-side surface of each of the fourth lens to the sixth lens may be concave.

A conditional expression 1.00<|f3/f|<15.00 may be satisfied, where f3 is a focal length of the third lens.

A conditional expression 5.00<TTL/BFL<10 may be satisfied, where BFL is a distance along the optical axis from an image-side surface of the ninth lens to the imaging plane.

A conditional expression 1.55<Fno<1.75 may be satisfied.

A conditional expression 0.20<T14/TTL<0.31 may be satisfied, where T14 is a distance along the optical axis from the object-side surface of the first lens to an object-side surface of the fourth lens.

Other features and aspects will be apparent from the following detailed description, the drawings, and the claims.

### BRIEF DESCRIPTION OF DRAWINGS

FIG. 1 is a configuration diagram illustrating an optical imaging system according to a first embodiment.

FIG. 2 is graphs illustrating aberration properties of the optical imaging system illustrated in FIG. 1.

FIG. 3 is a configuration diagram illustrating an optical imaging system according to a second embodiment.

FIG. 4 is graphs illustrating aberration properties of the optical imaging system illustrated in FIG. 3.

FIG. 5 is a configuration diagram illustrating an optical imaging system according to a third embodiment.

FIG. 6 is graphs illustrating aberration properties of the optical imaging system illustrated in FIG. 5.

FIG. 7 is a configuration diagram illustrating an optical imaging system according to a fourth embodiment.

FIG. 8 is graphs illustrating aberration properties of the optical imaging system illustrated in FIG. 7.

FIG. 9 is a configuration diagram illustrating an optical imaging system according to a fifth embodiment.

FIG. 10 is graphs illustrating aberration properties of the optical imaging system illustrated in FIG. 9.

FIG. 11 is a configuration diagram illustrating an optical imaging system according to a sixth embodiment.

FIG. 12 is graphs illustrating aberration properties of the optical imaging system illustrated in FIG. 11.

FIG. 13 is a configuration diagram illustrating an optical imaging system according to a seventh embodiment.

FIG. 14 is graphs illustrating aberration properties of the optical imaging system illustrated in FIG. 13.

FIG. 15 is a configuration diagram illustrating an optical imaging system according to an eighth embodiment.

FIG. 16 is graphs illustrating aberration properties of the optical imaging system illustrated in FIG. 15.

FIG. 17 is a configuration diagram illustrating an optical imaging system according to a ninth embodiment.

FIG. 18 is graphs illustrating aberration properties of the optical imaging system illustrated in FIG. 17.

FIG. 19 is a configuration diagram illustrating an optical imaging system according to a tenth embodiment.

FIG. 20 is graphs illustrating aberration properties of the optical imaging system illustrated in FIG. 19.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, a thickness, a size, and a shape of a lens may be exaggerated for ease of description, and a spherical shape or an aspherical shape of a lens is merely an example and is not limited thereto.

An optical imaging system according to an embodiment may include nine lenses.

A first lens may refer to a lens closest to an object side of the optical imaging system, and a ninth lens may refer to a lens closest to an imaging plane of the optical imaging system (or an image sensor).

In the embodiments, numerical values a radius of curvature, a thickness, a distance, and a focal length of a lens are expressed in millimeters, and a field of view (FOV) of the optical imaging system may be expressed degrees.

In a description of a shape of a lens, a statement that a surface of a lens is convex means that a paraxial region of the surface is convex, and a statement that a surface of a lens is concave means that a paraxial region of the surface is concave.

Accordingly, even when one surface of a lens is described being convex, an edge portion of the surface may be concave. Similarly, even when a surface of a lens is described as being concave, an edge portion of the surface may be convex.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging plane may refer to a virtual surface on which a focus is formed by the optical imaging system. Alternatively, the imaging plane may refer to a surface of an image sensor on which light is received through the optical imaging system.

An optical imaging system according to an embodiment may include at least nine lenses.

For example, an optical imaging system according to an embodiment may include a first lens, a second lens, a third lens, a fourth lens, a fifth lens, a sixth lens, a seventh lens, an eighth lens, and a ninth lens sequentially disposed in ascending numerical order along an optical axis of the optical imaging system from an object side of the optical imaging system toward an imaging plane of the optical imaging system. The first lens to the ninth lens may be spaced apart from each other by predetermined distances along the optical axis.

An optical imaging system according to an embodiment may further include an image sensor for converting an image of an object incident on the image sensor through the first lens to the ninth lens into an electrical signal.

Also, the optical imaging system may further include an infrared filter (hereinafter referred to as a “filter”) for blocking infrared rays. The filter may be disposed between the ninth lens and the image sensor.

Also, the optical imaging system may further include an stop for adjusting an amount of light passing through the optical imaging system.

The first lens to the ninth lens included in an optical imaging system according to an embodiment may be made of a plastic material.

Also, at least one lens of the first lens to the ninth lens may have an aspherical surface. For example, each of the first lens to the ninth lens may have at least one aspherical surface.

That is, either one or both of an object-side surface and an image-side surface of each of the first lens to the ninth lens may be aspherical. The aspherical surfaces of the first lens to the ninth lens may be represented by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment may satisfy any one or any combination of any two or more of Conditional Expressions 1 to 23 below.

0.90<(TTL/(2×IMG HT))×Fno<1.00 (Conditional Expression 1)

0<f1/f<5.00 (Conditional Expression 2)

0.8<|f2/f|<2.20 (Conditional Expression 3)

1.00<|f3/f<15.00 (Conditional Expression 4)

1.00<f4/f<4.00 (Conditional Expression 5)

−0.82<f9/f<0 (Conditional Expression 6)

0.80<f12/f<1.50 (Conditional Expression 7)

0.10<|f12/f3|<0.70 (Conditional Expression 8)

1.10<f123/f<1.70 (Conditional Expression 9)

1.00<TTL/f<1.50 (Conditional Expression 10)

5.00<TTL/BFL<10 (Conditional Expression 11)

3.00<ΣCT<5.00 (Conditional Expression 12)

2.00<ΣAT<4.00 (Conditional Expression 13)

1.00<ΣCT/ΣAT<2.00 (Conditional Expression 14)

5.00<Td<10.00 (Conditional Expression 15)

0.90<Td/f<1.50 (Conditional Expression 16)

0.15<Yc92/f<0.50 (Conditional Expression 17)

75°<FOV×(IMG HT/f)<82° (Conditional Expression 18)

0.55<TTL/(2×IMG HT)<0.65 (Conditional Expression 19)

1.55<Fno<1.75 (Conditional Expression 20)

18<v6−v5<39 (Conditional Expression 21)

15<|v6−v7|<35 (Conditional Expression 22)

0.20<T14/TTL<0.31 (Conditional Expression 23)

In an embodiment, the optical imaging system may satisfy 0.90<(TTL/(2×IMG HT))×Fno<1.00 (Conditional Expression 1). Here, TTL may be a distance along the optical axis from an object-side surface of the first lens to the imaging plane, IMG HT may be one half of a diagonal length of the imaging plane, and Fno may be an F-number of the optical imaging system. Accordingly, the optical imaging system may have a reduced size and may obtain bright images.

In an embodiment, the optical imaging system may satisfy 0<f1/f<5.00 (Conditional Expression 2), where f1 may be a focal length of the first lens, and f may be a focal length of the optical imaging system. Accordingly, aberrations may be reduced by appropriately adjusting the refractive power of the first lens.

In an embodiment, the optical imaging system may satisfy 0.8<|f2/f|<2.20 (Conditional Expression 3), where f2 may be a focal length of the second lens. Accordingly, aberrations may be reduced by appropriately adjusting the refractive power of the second lens.

In an embodiment, an optical imaging system may satisfy 1.00<|f3/f|<15.00 (Conditional Expression 4), where f3 may be a focal length of the third lens. Accordingly, aberrations may be reduced by appropriately adjusting the refractive power of the third lens.

In an embodiment, an optical imaging system may satisfy 1.00<f4/f<4.00 (Conditional Expression 5), where f4 may be a focal length of the fourth lens. Accordingly, aberrations may be reduced by appropriately adjusting the refractive power of the fourth lens.

In an embodiment, an optical imaging system may satisfy −0.82<f9/f<0 (Conditional Expression 6), where f9 may be a focal length of the ninth lens. Accordingly, aberrations may be reduced by appropriately adjusting the refractive power of the ninth lens.

In an embodiment, the optical imaging system may satisfy 0.80<f12/f<1.50 (Conditional Expression 7), where f12 may be a combined focal length of the first lens and the second lens. Accordingly, aberrations may be reduced by appropriately adjusting the refractive power of the first lens and the second lens.

In an embodiment, the optical imaging system may satisfy 0.10<|f12/f3|<0.70 (Conditional Expression 8), where f3 may be a focal length of the third lens. Accordingly, aberrations may be reduced by appropriately adjusting the refractive power of the first lens to the third lens.

In an embodiment, the optical imaging system may satisfy 1.10<f123/f<1.70 (Conditional Expression 9), where f123 may be a combined focal length of the first lens, the second lens, and the third lens. Accordingly, aberrations may be reduced by appropriately adjusting the refractive power of the first lens to the third lens.

In an embodiment, the optical imaging system may satisfy 1.00<TTL/f<1.50 (Conditional Expression 10). Accordingly, the optical imaging system may be miniaturized while improving an image resolution.

In an embodiment, the optical imaging system may satisfy 5.00<TTL/BFL<10 (Conditional Expression 11). Here, BFL may be a distance along the optical axis from an image-side surface of the ninth lens to the imaging plane. Accordingly, the optical imaging system may be miniaturized and a sufficient movement space may be ensured during autofocusing.

In an embodiment, the optical imaging system may satisfy 3.00<ΣCT<5.00 (Conditional Expression 12). Here, ΣCT may be a sum of thicknesses of the first lens to the ninth lens along the optical axis. Accordingly, aberrations may be improved by optimizing the thickness of each lens.

In an embodiment, the optical imaging system may satisfy 2.00<ΣAT<4.00 (Conditional Expression 13), where ΣAT may be a sum of air gaps between adjacent ones of the first lens to ninth lens. Accordingly, aberrations may be improved by optimizing the air gaps between the first lens to the ninth lens

In an embodiment, the optical imaging system may satisfy 1.00<ΣCT/ΣAT<2.00 (Conditional Expression 14). Accordingly, aberrations may be improved by optimizing the thickness of each lens and the air gaps between the lenses.

In an embodiment, the optical imaging system may satisfy 5.00<Td<10.00 (Conditional Expression 15), where Td may be a distance along the optical axis from the object-side surface of the first lens to the image-side surface of the ninth lens. Accordingly, the optical imaging system may be miniaturized.

In an embodiment, the optical imaging system may satisfy 0.90<Td/f<1.50 (Conditional Expression 16). Accordingly, the optical imaging system may be miniaturized.

In an embodiment, the optical imaging system may satisfy 0.15<Yc92/f<0.50 (Conditional Expression 17), where Yc92 may be a distance from the optical axis to an inflection point on the image-side surface of the ninth lens in a direction perpendicular to the optical axis. Accordingly, aberrations may be improved by optimizing the position of the inflection point on the image-side surface of the ninth lens.

In an embodiment, the optical imaging system may satisfy 75°<FOV×(IMG HT/f)<82° (Conditional Expression 18), where FOV may be a field of view of the optical imaging system. Accordingly, an image resolution may be improved.

In an embodiment, the optical imaging system may satisfy 0.55<TTL/(2×IMG HT)<0.65 (Conditional Expression 19). Accordingly, the optical imaging system may be miniaturized while improving an image resolution.

In an embodiment, the optical imaging system may satisfy 1.55<Fno<1.75 (Conditional Expression 20). Accordingly, an image brightness and an image resolution may be improved.

In an embodiment, the optical imaging system may satisfy 18<v6−v5<39 (Conditional Expression 21). Here, v6 may be an Abbe number of the sixth lens, and v5 may be an Abbe number of the fifth lens. Accordingly, chromatic aberration may be improved.

In an embodiment, the optical imaging system may satisfy 15<|v6−v7|<35 (Conditional Expression 22). Here, v7 may be an Abbe number of the seventh lens. Accordingly, chromatic aberration may be improved,

In an embodiment, the optical imaging system may satisfy 0.20<T14/TTL<0.31 (Conditional Expression 23). Here, T14 may be a distance along the optical axis from the object-side surface of the first lens to an object-side surface of the fourth lens. Accordingly, the optical imaging system may be miniaturized.

In an embodiment, among the first lens to the fifth lens, at least two lenses may have a refractive index of 1.63 or more. For example, the second lens or the third lens may have a refractive index of 1.63 or more, and the fifth lens may have a refractive index of 1.67 or more.

Among the first lens to the third lens, at least one lens may have a negative refractive power and a refractive index of 1.63 or more. For example, among the second lens and the third lens, a lens having a negative refractive power may have a refractive index of 1.63 or more.

In an embodiment, an absolute value of the focal length of the ninth lens may be the smallest among the first lens to the ninth lens.

In an embodiment, the combined focal length of the first lens and the second lens may have a positive value.

In an embodiment, the combined focal length of the first lens to the third lens may have a positive value.

The optical imaging system may be configured to have a field of view greater than 80°. In an embodiment, the field of view of the optical imaging system may be less than 87°.

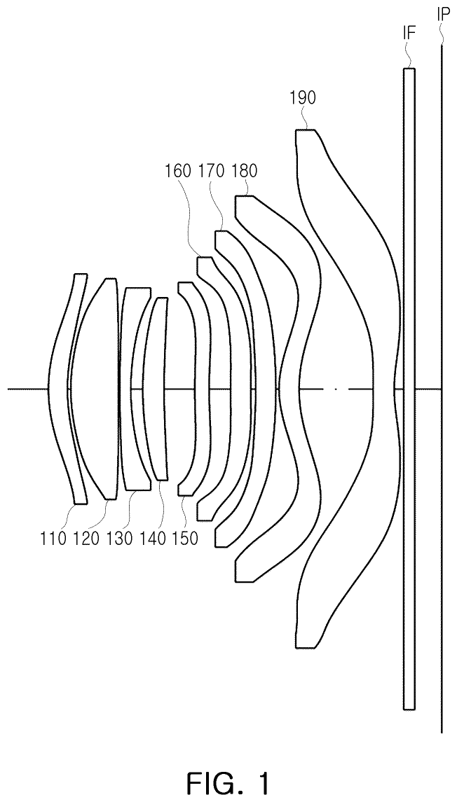

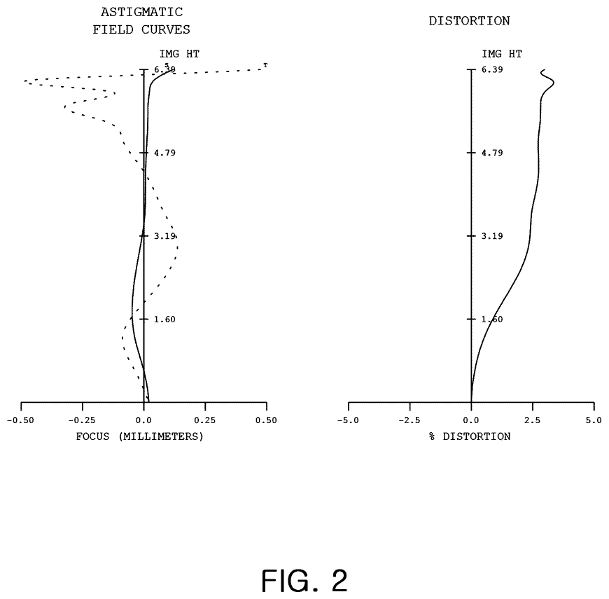

FIG. 1 is a configuration diagram illustrating an optical imaging system according to a first embodiment, and FIG. 2 is graphs illustrating aberration properties of the optical imaging system illustrated in FIG. 1.

Referring to FIG. 1, the optical imaging system according to the first embodiment may include a first lens 110, a second lens 120, a third lens 130, a fourth lens 140, a fifth lens 150, a sixth lens 160, a seventh lens 170, an eighth lens 180, and a ninth lens 190 sequentially disposed in ascending numerical order along an optical axis of the optical imaging system from an object side of the optical imaging system toward an imaging plane IP of the optical imaging system, and may further include a filter IF disposed between the ninth lens 190 and the imaging plane IP.

The optical imaging system according to the first embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 1 below.

TABLE 1

| Surface | | Radius of | Thickness or | Refractive | Abbe |
|---|---|---|---|---|---|
| No. | Element | Curvature | Distance | Index | Number |
| S1 | First | 2.806 | 0.360 | 1.544 | 56.0 |
| S2 | Lens | 3.258 | 0.065 | | |
| S3 | Second | 3.444 | 0.898 | 1.544 | 56.0 |
| S4 | Lens | 117.505 | 0.030 | | |
| S5 | Third | 18.448 | 0.210 | 1.639 | 23.5 |
| S6 | Lens | 4.484 | 0.226 | | |
| S7 | Fourth | 5.647 | 0.406 | 1.544 | 56.0 |
| S8 | Lens | 14.651 | 0.581 | | |
| S9 | Fifth | 10.490 | 0.272 | 1.671 | 19.2 |
| S10 | Lens | 7.872 | 0.410 | | |
| S11 | Sixth | 18.769 | 0.380 | 1.544 | 56.0 |
| S12 | Lens | 12.681 | 0.096 | | |
| S13 | Seventh | −7.135 | 0.380 | 1.614 | 25.9 |
| S14 | Lens | −8.866 | 0.060 | | |
| S15 | Eighth | 1.761 | 0.382 | 1.544 | 56.0 |
| S16 | Lens | 2.707 | 1.404 | | |
| S17 | Ninth | 39.354 | 0.400 | 1.535 | 55.7 |
| S18 | Lens | 2.584 | 0.182 | | |
| S19 | Filter | Infinity | 0.210 | 1.517 | 64.2 |
| S20 | | Infinity | 0.507 | | |
| S21 | Imaging | Infinity | | | |
| | Plane | | | | |

In a first embodiment, the first lens 110 may have a positive refractive power, an object-side surface of the first lens 110 may be convex in a paraxial region thereof, and an image-side surface of the first lens 110 may be concave in a paraxial region thereof.

The second lens 120 may have a positive refractive power, an object-side surface of the second lens 120 may be convex in a paraxial region thereof, and an image-side surface of the second lens 120 may be concave in a paraxial region thereof.

The third lens 130 may have a negative refractive power, an object-side surface of the third lens 130 may be convex in a paraxial region thereof, and an image-side surface of the third lens 130 may be concave in a paraxial region thereof.

The fourth lens 140 may have a positive refractive power, an object-side surface of the fourth lens 140 may be convex in a paraxial region thereof, and an image-side surface of the fourth lens 140 may be concave in a paraxial region thereof.

The fifth lens 150 may have a negative refractive power, an object-side surface of the fifth lens 150 may be convex in a paraxial region thereof, and an image-side surface of the fifth lens 150 may be concave in a paraxial region thereof.

The sixth lens 160 may have a negative refractive power, an object-side surface of the sixth lens 160 may be convex in a paraxial region thereof, and an image-side surface of the sixth lens 160 may be concave in a paraxial region thereof.

The seventh lens 170 may have a negative refractive power, an object-side surface of the seventh lens 170 may be concave in a paraxial region thereof, and an image-side surface of the seventh lens 170 may be convex in a paraxial region thereof.

The eighth lens 180 may have a positive refractive power, an object-side surface of the eighth lens 180 may be convex in a paraxial region thereof, and an image-side surface of the eighth lens 180 may be concave in a paraxial region thereof.

The ninth lens 190 may have a negative refractive power, an object-side surface of the ninth lens 190 may be convex in a paraxial region thereof, and an image-side surface of the ninth lens 190 may be concave in a paraxial region thereof.

Also, any one or any combination of any two or more of the fifth lens 150, the sixth lens 160, the eighth lens 180, and the ninth lens 190 may have at least one inflection point on either one or both of the object-side surface and the image-side surface.

Each surface of each of the first lens 110 to the ninth lens 190 may have aspherical coefficients as listed in Table 2 below. For example, the object-side surface and the image-side surface of each of the first lens 110 to the ninth lens 190 may be aspherical.

TABLE 2

| | S1 | S2 | S3 | S4 | S5 | S6 |
|---|---|---|---|---|---|---|
| K | −5.608E+00 | −1.204E+01 | −3.915E+00 | 3.770E+01 | 1.555E+01 | 4.517E+00 |
| A | 1.760E−02 | 2.438E−02 | 2.855E−02 | 2.620E−02 | −1.247E−02 | −1.166E−02 |
| B | 2.611E−03 | −8.177E−02 | −1.777E−01 | −1.616E−01 | 1.433E−02 | −1.863E−02 |
| C | −3.545E−02 | 1.422E−01 | 4.675E−01 | 4.511E−01 | −4.340E−02 | 9.867E−02 |
| D | 7.374E−02 | −1.373E−01 | −7.480E−01 | −7.739E−01 | 1.225E−01 | −3.440E−01 |
| E | −9.501E−02 | 4.508E−02 | 8.063E−01 | 8.812E−01 | −2.146E−01 | 8.551E−01 |
| F | 8.236E−02 | 4.974E−02 | −6.122E−01 | −6.958E−01 | 2.434E−01 | −1.451E+00 |
| G | −5.026E−02 | −7.547E−02 | 3.374E−01 | 3.902E−01 | −1.865E−01 | 1.689E+00 |
| H | 2.210E−02 | 5.010E−02 | −1.371E−01 | −1.568E−01 | 9.881E−02 | −1.370E+00 |
| J | −7.043E−03 | −2.061E−02 | 4.127E−02 | 4.490E−02 | −3.642E−02 | 7.814E−01 |
| L | 1.611E−03 | 5.647E−03 | −9.110E−03 | −8.975E−03 | 9.209E−03 | −3.121E−01 |
| M | −2.578E−04 | −1.036E−03 | 1.436E−03 | 1.195E−03 | −1.534E−03 | 8.550E−02 |
| N | 2.738E−05 | 1.229E−04 | −1.534E−04 | −9.657E−05 | 1.542E−04 | −1.532E−02 |
| O | −1.734E−06 | −8.535E−06 | 9.939E−06 | 3.797E−06 | −7.589E−06 | 1.616E−03 |
| P | 4.956E−08 | 2.641E−07 | −2.951E−07 | −2.795E−08 | 7.970E−08 | −7.617E−05 |

| | S7 | S8 | S9 | S10 | S11 | S12 |
|---|---|---|---|---|---|---|
| K | −4.188E+00 | −5.965E+01 | −8.366E+01 | −5.062E+01 | −4.969E+01 | 1.685E+01 |
| A | −1.398E−03 | −1.463E−02 | −2.028E−02 | −2.940E−02 | −8.838E−02 | −1.415E−01 |
| B | 2.732E−04 | 1.034E−01 | −6.406E−02 | −1.514E−02 | 6.118E−02 | 1.459E−01 |
| C | −1.078E−02 | −5.051E−01 | 2.369E−01 | 1.028E−01 | 1.558E−02 | −1.747E−01 |
| D | 5.455E−02 | 1.554E+00 | −5.049E−01 | −2.606E−01 | −1.256E−01 | 1.879E−01 |
| E | −1.387E−01 | −3.198E+00 | 6.590E−01 | 4.000E−01 | 2.084E−01 | −1.489E−01 |
| F | 2.220E−01 | 4.567E+00 | −5.291E−01 | −4.233E−01 | −2.131E−01 | 8.447E−02 |
| G | −2.411E−01 | −4.630E+00 | 2.221E−01 | 3.229E−01 | 1.509E−01 | −3.538E−02 |
| H | 1.835E−01 | 3.372E+00 | 1.373E−02 | −1.801E−01 | −7.673E−02 | 1.128E−02 |
| J | −9.867E−02 | −1.768E+00 | −7.984E−02 | 7.338E−02 | 2.827E−02 | −2.752E−03 |
| L | 3.730E−02 | 6.610E−01 | 5.194E−02 | −2.156E−02 | −7.492E−03 | 5.020E−04 |
| M | −9.691E−03 | −1.717E−01 | −1.830E−02 | 4.439E−03 | 1.391E−03 | −6.545E−05 |
| N | 1.647E−03 | 2.944E−02 | 3.848E−03 | −6.063E−04 | −1.718E−04 | 5.690E−06 |
| O | −1.651E−04 | −2.995E−03 | −4.549E−04 | 4.928E−05 | 1.265E−05 | −2.929E−07 |
| P | 7.413E−06 | 1.369E−04 | 2.338E−05 | −1.800E−06 | −4.203E−07 | 6.720E−09 |

| | S13 | S14 | S15 | S16 | S17 | S18 |
|---|---|---|---|---|---|---|
| K | 3.904E+00 | 5.950E+00 | −6.406E+00 | −1.085E+01 | 1.340E+01 | −1.449E+01 |
| A | 7.464E−02 | 9.772E−03 | 1.080E−02 | 6.193E−02 | −1.402E−01 | −6.656E−02 |
| B | −9.868E−02 | −2.540E−02 | −1.759E−02 | −5.439E−02 | 8.310E−02 | 3.144E−02 |
| C | 9.638E−02 | 4.127E−02 | 4.447E−03 | 2.766E−02 | −3.798E−02 | −1.062E−02 |
| D | −7.224E−02 | −4.656E−02 | 1.522E−03 | −1.045E−02 | 1.310E−02 | 2.439E−03 |
| E | 4.604E−02 | 3.817E−02 | −2.080E−03 | 2.917E−03 | −3.268E−03 | −3.639E−04 |
| F | −2.491E−02 | −2.246E−02 | 9.886E−04 | −6.227E−04 | 5.827E−04 | 3.072E−05 |
| G | 1.001E−02 | 9.271E−03 | −2.942E−04 | 1.076E−04 | −7.463E−05 | −4.771E−07 |
| H | −2.645E−03 | −2.673E−03 | 6.241E−05 | −1.562E−05 | 6.911E−06 | −2.105E−07 |
| J | 4.016E−04 | 5.389E−04 | −9.696E−06 | 1.875E−06 | −4.631E−07 | 2.767E−08 |
| L | −1.876E−05 | −7.563E−05 | 1.080E−06 | −1.755E−07 | 2.223E−08 | −1.843E−09 |
| M | −4.500E−06 | 7.240E−06 | −8.226E−08 | 1.192E−08 | −7.455E−10 | 7.526E−11 |
| N | 9.109E−07 | −4.509E−07 | 3.996E−09 | −5.418E−10 | 1.658E−11 | −1.903E−12 |
| O | −6.846E−08 | 1.647E−08 | −1.094E−10 | 1.458E−11 | −2.198E−13 | 2.749E−14 |
| P | 1.957E−09 | −2.678E−10 | 1.250E−12 | −1.747E−13 | 1.314E−15 | −1.740E−16 |

The optical imaging system configured as described above may have the aberration properties illustrated in FIG. 2.

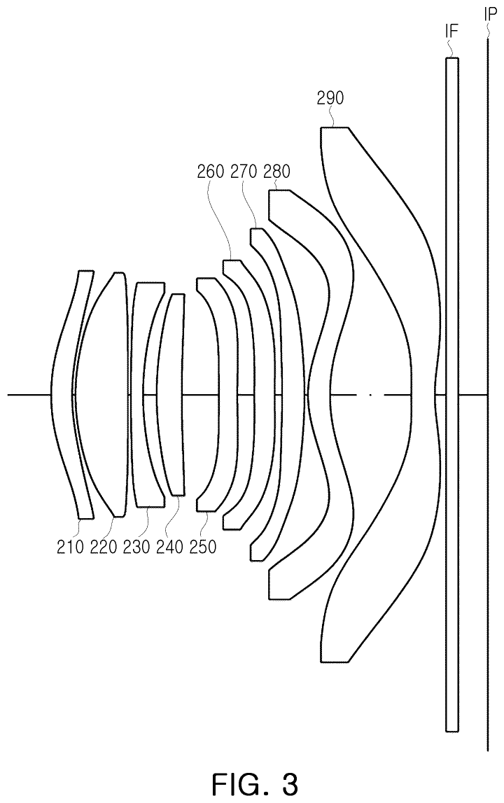

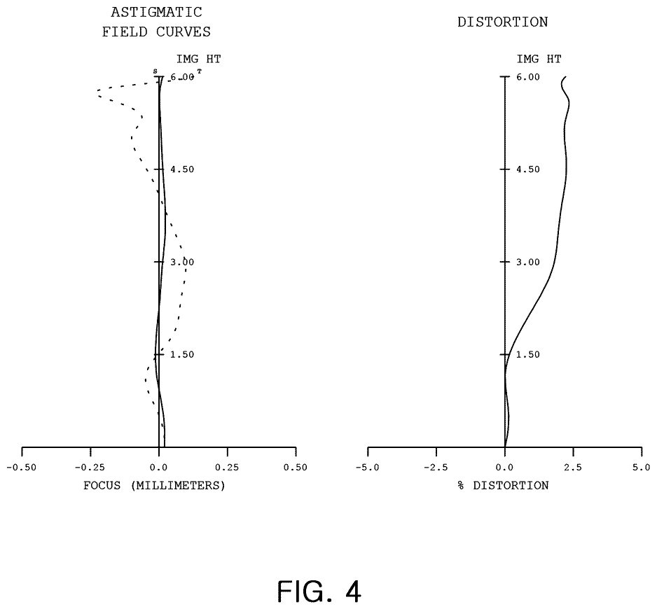

FIG. 3 is a configuration diagram illustrating an optical imaging system according to a second embodiment, and FIG. 4 is graphs illustrating aberration properties of the optical imaging system illustrated in FIG. 3.

Referring to FIG. 3, the optical imaging system according to the second embodiment may include a first lens 210, a second lens 220, a third lens 230, a fourth lens 240, a fifth lens 250, a sixth lens 260, a seventh lens 270, an eighth lens 280, and a ninth lens 290 sequentially disposed in ascending numerical order along an optical axis of the optical imaging system from an object side of the optical imaging system toward an imaging plane IP of the optical imaging system, and may further include a filter IF disposed between the ninth lens 290 and the imaging plane IP.

The optical imaging system according to the second embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 3 below.

TABLE 3

| Surface | | Radius of | Thickness or | Refractive | Abbe |
|---|---|---|---|---|---|
| No. | Element | Curvature | Distance | Index | Number |
| S1 | First | 2.882 | 0.360 | 1.544 | 56.0 |
| S2 | Lens | 3.318 | 0.058 | | |
| S3 | Second | 3.399 | 0.900 | 1.544 | 56.0 |
| S4 | Lens | 787.475 | 0.050 | | |
| S5 | Third | 21.292 | 0.210 | 1.639 | 23.5 |
| S6 | Lens | 4.484 | 0.234 | | |
| S7 | Fourth | 5.663 | 0.431 | 1.544 | 56.0 |
| S8 | Lens | 19.600 | 0.636 | | |
| S9 | Fifth | 530.700 | 0.319 | 1.671 | 19.2 |
| S10 | Lens | 19.292 | 0.292 | | |
| S11 | Sixth | 26.813 | 0.348 | 1.544 | 56.0 |
| S12 | Lens | 11.080 | 0.130 | | |
| S13 | Seventh | −10.329 | 0.380 | 1.614 | 25.9 |
| S14 | Lens | −8.561 | 0.062 | | |
| S15 | Eighth | 1.791 | 0.377 | 1.544 | 56.0 |
| S16 | Lens | 2.744 | 1.401 | | |
| S17 | Ninth | −49.803 | 0.400 | 1.535 | 55.7 |
| S18 | Lens | 2.608 | 0.196 | | |
| S19 | Filter | Infinity | 0.210 | 1.517 | 64.2 |
| S20 | | Infinity | 0.505 | | |
| S21 | Imaging | Infinity | | | |
| | Plane | | | | |

In a second embodiment, the first lens 210 may have a positive refractive power, an object-side surface of the first lens 210 may be convex in a paraxial region thereof, and an image-side surface of the first lens 210 may be concave in a paraxial region thereof.

The second lens 220 may have a positive refractive power, an object-side surface of the second lens 220 may be convex in a paraxial region thereof, and an image-side surface of the second lens 220 may be concave in a paraxial region thereof.

The third lens 230 may have a negative refractive power, an object-side surface of the third lens 230 may be convex in a paraxial region thereof, and an image-side surface of the third lens 230 may be concave in a paraxial region thereof.

The fourth lens 240 may have a positive refractive power, an object-side surface of the fourth lens 240 may be convex in a paraxial region thereof, and an image-side surface of the fourth lens 240 may be concave in a paraxial region thereof.

The fifth lens 250 may have a negative refractive power, an object-side surface of the fifth lens 250 may be convex in a paraxial region thereof, and an image-side surface of the fifth lens 250 may be concave in a paraxial region thereof.

The sixth lens 260 may have a negative refractive power, an object-side surface of the sixth lens 260 may be convex in a paraxial region thereof, and an image-side surface of the sixth lens 260 may be concave in a paraxial region thereof.

The seventh lens 270 may have a positive refractive power, an object-side surface of the seventh lens 270 may be concave in a paraxial region thereof, and an image-side surface of the seventh lens 270 may be convex in a paraxial region thereof.

The eighth lens 280 may have a positive refractive power, an object-side surface of the eighth lens 280 may be convex in a paraxial region thereof, and an image-side surface of the eighth lens 280 may be concave in a paraxial region thereof.

The ninth lens 290 may have a negative refractive power, and an object-side surface and an image-side surface of the ninth lens 290 may be concave in respective paraxial regions thereof.

Also, any one or any combination of any two or more of the fifth lens 250, the sixth lens 260, the eighth lens 280, and the ninth lens 290 may have at least one inflection point on either one or both of the object-side surface and the image-side surface.

Each surface of each of the first lens 210 to the ninth lens 290 may have aspherical coefficients as listed in Table 4 below. For example, the object-side surface and the image-side surface of each of the first lens 210 to the ninth lens 290 may be aspherical.

TABLE 4

| | S1 | S2 | S3 | S4 | S5 | S6 |
|---|---|---|---|---|---|---|
| K | −5.964E+00 | −1.163E+01 | −3.634E+00 | −9.900E+01 | 1.554E+01 | 4.517E+00 |
| A | 1.930E−02 | 2.811E−02 | 2.885E−02 | 2.196E−02 | −5.228E−03 | −7.666E−03 |
| B | −4.689E−03 | −9.641E−02 | −1.827E−01 | −1.563E−01 | −4.662E−02 | −1.020E−01 |
| C | −1.404E−02 | 1.758E−01 | 5.061E−01 | 5.016E−01 | 2.140E−01 | 6.171E−01 |
| D | 3.395E−02 | −1.840E−01 | −8.674E−01 | −1.002E+00 | −5.337E−01 | −2.091E+00 |
| E | −4.777E−02 | 7.638E−02 | 1.011E+00 | 1.344E+00 | 8.644E−01 | 4.502E+00 |
| F | 4.500E−02 | 5.470E−02 | −8.356E−01 | −1.261E+00 | −9.551E−01 | −6.543E+00 |
| G | −3.005E−02 | −1.039E−01 | 5.041E−01 | 8.492E−01 | 7.422E−01 | 6.652E+00 |
| H | 1.458E−02 | 7.643E−02 | −2.253E−01 | −4.154E−01 | −4.125E−01 | −4.823E+00 |
| J | −5.151E−03 | −3.424E−02 | 7.479E−02 | 1.479E−01 | 1.648E−01 | 2.509E+00 |
| L | 1.308E−03 | 1.015E−02 | −1.825E−02 | −3.791E−02 | −4.701E−02 | −9.287E−01 |
| M | −2.320E−04 | −2.007E−03 | 3.182E−03 | 6.823E−03 | 9.340E−03 | 2.388E−01 |
| N | 2.726E−05 | 2.557E−04 | −3.754E−04 | −8.185E−04 | −1.230E−03 | −4.054E−02 |
| O | −1.904E−06 | −1.903E−05 | 2.684E−05 | 5.881E−05 | 9.653E−05 | 4.084E−03 |
| P | 5.984E−08 | 6.300E−07 | −8.775E−07 | −1.916E−06 | −3.424E−06 | −1.849E−04 |

| | S7 | S8 | S9 | S10 | S11 | S12 |
|---|---|---|---|---|---|---|
| K | −4.194E+00 | −5.933E+01 | −8.422E+01 | −9.900E+01 | −1.325E+01 | 1.611E+01 |
| A | 7.556E−03 | −4.389E−03 | −3.270E−02 | −3.236E−02 | −8.389E−02 | −1.808E−01 |
| B | −2.805E−02 | 3.522E−02 | 6.623E−02 | 4.019E−02 | 1.367E−02 | 3.236E−01 |
| C | 6.764E−02 | −1.407E−01 | −3.028E−01 | −1.246E−01 | 2.544E−01 | −5.282E−01 |
| D | −1.218E−01 | 3.046E−01 | 7.931E−01 | 2.568E−01 | −7.439E−01 | 6.103E−01 |
| E | 1.585E−01 | −3.857E−01 | −1.394E+00 | −3.724E−01 | 1.184E+00 | −4.881E−01 |
| F | −1.479E−01 | 2.432E−01 | 1.725E+00 | 3.854E−01 | −1.236E+00 | 2.744E−01 |
| G | 9.626E−02 | 3.494E−02 | −1.540E+00 | −2.885E−01 | 8.958E−01 | −1.096E−01 |
| H | −4.020E−02 | −2.142E−01 | 1.002E+00 | 1.573E−01 | −4.631E−01 | 3.089E−02 |
| J | 7.669E−03 | 2.053E−01 | −4.762E−01 | −6.234E−02 | 1.721E−01 | −5.909E−03 |
| L | 1.789E−03 | −1.099E−01 | 1.631E−01 | 1.772E−02 | −4.565E−02 | 6.878E−04 |
| M | −1.656E−03 | 3.687E−02 | −3.919E−02 | −3.517E−03 | 8.437E−03 | −2.947E−05 |
| N | 4.928E−04 | −7.708E−03 | 6.263E−03 | 4.618E−04 | −1.032E−03 | −3.475E−06 |
| O | −7.242E−05 | 9.217E−04 | −5.976E−04 | −3.602E−05 | 7.504E−05 | 5.446E−07 |
| P | 4.394E−06 | −4.824E−05 | 2.575E−05 | 1.263E−06 | −2.456E−06 | −2.270E−08 |

| | S13 | S14 | S15 | S16 | S17 | S18 |
|---|---|---|---|---|---|---|
| K | 9.677E+00 | 4.103E+00 | −6.426E+00 | −1.076E+01 | −9.900E+01 | −1.365E+01 |
| A | 4.185E−02 | 1.712E−02 | 9.920E−03 | 6.314E−02 | −1.545E−01 | −9.463E−02 |
| B | 2.275E−02 | −5.698E−02 | −9.994E−03 | −5.924E−02 | 1.041E−01 | 5.573E−02 |
| C | −1.271E−01 | 1.046E−01 | −1.283E−02 | 3.364E−02 | −5.181E−02 | −2.229E−02 |
| D | 1.853E−01 | −1.187E−01 | 2.347E−02 | −1.467E−02 | 1.870E−02 | 6.104E−03 |
| E | −1.604E−01 | 9.076E−02 | −1.981E−02 | 4.876E−03 | −4.763E−03 | −1.160E−03 |
| F | 9.437E−02 | −4.858E−02 | 1.064E−02 | −1.260E−03 | 8.523E−04 | 1.535E−04 |
| G | −4.010E−02 | 1.843E−02 | −3.959E−03 | 2.565E−04 | −1.076E−04 | −1.413E−05 |
| H | 1.261E−02 | −4.974E−03 | 1.049E−03 | −4.090E−05 | 9.590E−06 | 8.854E−07 |
| J | −2.937E−03 | 9.558E−04 | −1.991E−04 | 4.993E−06 | −5.967E−07 | −3.506E−08 |
| L | 4.978E−04 | −1.295E−04 | 2.674E−05 | −4.516E−07 | 2.513E−08 | 6.464E−10 |
| M | −5.932E−05 | 1.209E−05 | −2.480E−06 | 2.900E−08 | −6.668E−10 | 1.073E−11 |
| N | 4.685E−06 | −7.394E−07 | 1.507E−07 | −1.242E−09 | 9.260E−12 | −9.424E−13 |
| O | −2.191E−07 | 2.666E−08 | −5.397E−09 | 3.167E−11 | −2.063E−14 | 2.200E−14 |
| P | 4.579E−09 | −4.295E−10 | 8.627E−11 | −3.625E−13 | −7.032E−16 | −1.917E−16 |

The optical imaging system configured as described above may have the aberration properties illustrated in FIG. 4.

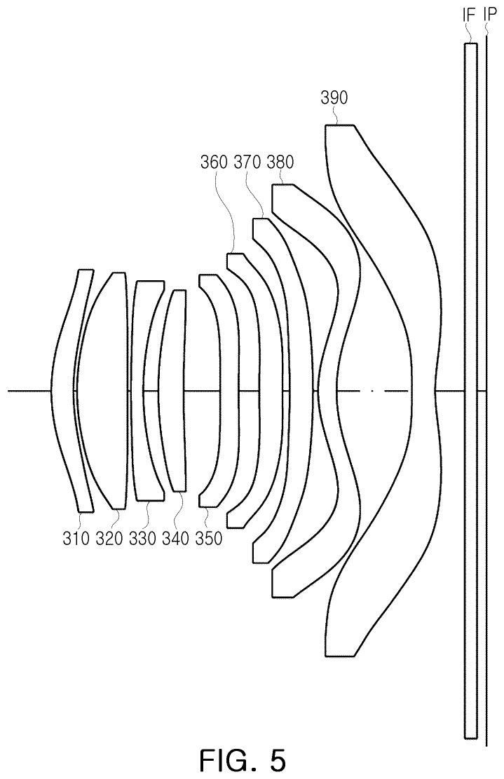

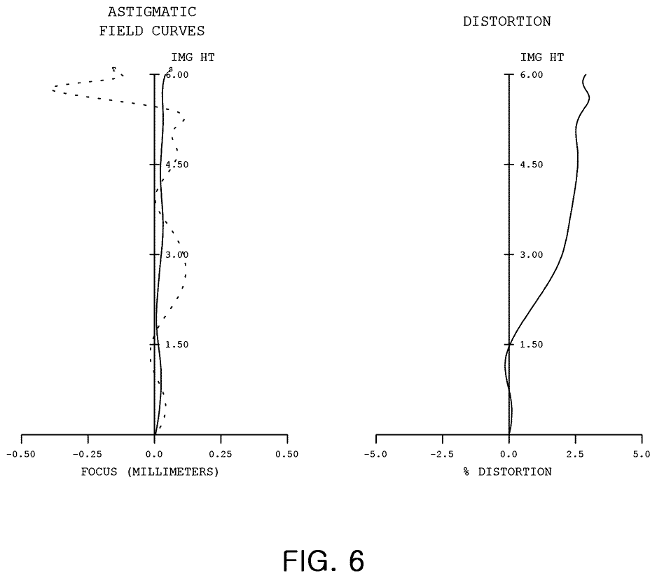

FIG. 5 is a configuration diagram illustrating an optical imaging system according to a third embodiment, and FIG. 6 is graphs illustrating aberration properties of the optical imaging system illustrated in FIG. 5.

Referring to FIG. 5, the optical imaging system according to the third embodiment may include a first lens 310, a second lens 320, a third lens 330, a fourth lens 340, a fifth lens 350, a sixth lens 360, a seventh lens 370, an eighth lens 380, and a ninth lens 390 sequentially disposed in ascending numerical order along an optical axis of the optical imaging system from an object side of the optical imaging system toward an imaging plane IP of the optical imaging system, and may further include a filter IF disposed between the ninth lens 390 and the imaging plane IP.

The optical imaging system according to the third embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 5 below.

TABLE 5

| Surface | | Radius of | Thickness or | Refractive | Abbe |
|---|---|---|---|---|---|
| No. | Element | Curvature | Distance | Index | Number |
| S1 | First | 2.888 | 0.379 | 1.544 | 56.0 |
| S2 | Lens | 3.506 | 0.063 | | |
| S3 | Second | 3.588 | 0.864 | 1.544 | 56.0 |
| S4 | Lens | 233.093 | 0.061 | | |
| S5 | Third | 20.005 | 0.210 | 1.639 | 23.5 |
| S6 | Lens | 4.484 | 0.259 | | |
| S7 | Fourth | 5.668 | 0.433 | 1.544 | 56.0 |
| S8 | Lens | 19.508 | 0.626 | | |
| S9 | Fifth | 75.947 | 0.317 | 1.671 | 19.2 |
| S10 | Lens | 15.921 | 0.354 | | |
| S11 | Sixth | 10.978 | 0.399 | 1.544 | 56.0 |
| S12 | Lens | 15.963 | 0.125 | | |
| S13 | Seventh | −9.748 | 0.398 | 1.614 | 25.9 |
| S14 | Lens | −9.207 | 0.087 | | |
| S15 | Eighth | 1.930 | 0.318 | 1.544 | 56.0 |
| S16 | Lens | 2.649 | 1.291 | | |
| S17 | Ninth | −57.160 | 0.400 | 1.535 | 55.7 |
| S18 | Lens | 2.497 | 0.509 | | |
| S19 | Filter | Infinity | 0.210 | 1.517 | 64.2 |
| S20 | | Infinity | 0.165 | | |
| S21 | Imaging | Infinity | | | |
| | Plane | | | | |

In the third embodiment, the first lens 310 may a have positive refractive power, an object-side surface of the first lens 310 may be convex in a paraxial region thereof, and an image-side surface of the first lens 310 may be concave in a paraxial region thereof.

The second lens 320 may have a positive refractive power, an object-side surface of the second lens 320 may be convex in a paraxial region thereof, and an image-side surface of the second lens 320 may be concave in a paraxial region thereof.

The third lens 330 may have a negative refractive power, an object-side surface of the third lens 330 may be convex in a paraxial region thereof, and an image-side surface of the third lens 330 may be concave in a paraxial region thereof.

The fourth lens 340 may have a positive refractive power, an object-side surface of the fourth lens 340 may be convex in a paraxial region thereof, and an image-side surface of the fourth lens 340 may be concave in a paraxial region thereof.

The fifth lens 350 may have a negative refractive power, an object-side surface of the fifth lens 350 may be convex in a paraxial region thereof, and an image-side surface of the fifth lens 350 may be concave in a paraxial region thereof.

The sixth lens 360 may have a positive refractive power, an object-side surface of the sixth lens 360 may be convex in a paraxial region thereof, and an image-side surface of the sixth lens 360 may be concave in a paraxial region thereof.

The seventh lens 370 may have a positive refractive power, an object-side surface of the seventh lens 370 may be concave in a paraxial region thereof, and an image-side surface of the seventh lens 370 may be convex in a paraxial region thereof.

The eighth lens 380 may have a positive refractive power, an object-side surface of the eighth lens 380 may be convex in a paraxial region thereof, and an image-side surface of the eighth lens 380 may be concave in a paraxial region thereof.

The ninth lens 390 may have a negative refractive power, and an object-side surface and an image-side surface of the ninth lens 390 may be concave in respective paraxial regions thereof.

Also, any one or any combination of any two or more of the fifth lens 350, the sixth lens 360, the eighth lens 380, and the ninth lens 390 may have at least one inflection point on either one or both of the object-side surface and the image-side surface.

Each surface of each of the first lens 310 to the ninth lens 390 may have aspherical coefficients as listed in Table 6 below. For example, the object-side surface and the image-side surface of each of the first lens 310 to the ninth lens 390 may be aspherical.

TABLE 6

| | S1 | S2 | S3 | S4 | S5 | S6 |
|---|---|---|---|---|---|---|
| K | −5.968E+00 | −1.257E+01 | −3.577E+00 | 9.900E+01 | 1.542E+01 | 4.517E+00 |
| A | 1.810E−02 | 2.628E−02 | 1.592E−02 | 9.163E−03 | −2.347E−03 | −2.370E−02 |
| B | 1.144E−02 | −9.747E−02 | −1.173E−01 | −5.810E−02 | −4.106E−02 | 5.894E−02 |
| C | −8.262E−02 | 2.327E−01 | 3.440E−01 | 1.642E−01 | 1.789E−01 | −1.727E−01 |
| D | 1.969E−01 | −4.052E−01 | −6.225E−01 | −3.155E−01 | −4.908E−01 | 2.274E−01 |
| E | −2.968E−01 | 4.992E−01 | 7.574E−01 | 4.198E−01 | 8.892E−01 | 2.828E−02 |
| F | 3.047E−01 | −4.378E−01 | −6.384E−01 | −3.935E−01 | −1.090E+00 | −5.680E−01 |
| G | −2.204E−01 | 2.764E−01 | 3.797E−01 | 2.641E−01 | 9.318E−01 | 9.710E−01 |
| H | 1.142E−01 | −1.263E−01 | −1.602E−01 | −1.281E−01 | −5.672E−01 | −9.227E−01 |
| J | −4.246E−02 | 4.164E−02 | 4.747E−02 | 4.487E−02 | 2.476E−01 | 5.699E−01 |
| L | 1.122E−02 | −9.776E−03 | −9.580E−03 | −1.123E−02 | −7.699E−02 | −2.381E−01 |
| M | −2.056E−03 | 1.589E−03 | 1.232E−03 | 1.952E−03 | 1.665E−02 | 6.700E−02 |
| N | 2.479E−04 | −1.693E−04 | −8.581E−05 | −2.233E−04 | −2.380E−03 | −1.220E−02 |
| O | −1.768E−05 | 1.061E−05 | 1.545E−06 | 1.504E−05 | 2.022E−04 | 1.299E−03 |
| P | 5.649E−07 | −2.949E−07 | 1.038E−07 | −4.495E−07 | −7.725E−06 | −6.153E−05 |

| | S7 | S8 | S9 | S10 | S11 | S12 |
|---|---|---|---|---|---|---|
| K | −4.373E+00 | −9.579E+01 | −8.467E+01 | −9.844E+01 | −9.895E+01 | 2.285E+01 |
| A | 6.216E−03 | 5.697E−03 | −2.085E−02 | −2.231E−02 | −9.522E−02 | −1.250E−01 |
| B | −3.068E−02 | −3.374E−02 | −2.770E−02 | −7.015E−02 | 1.334E−01 | 9.979E−02 |
| C | 1.465E−01 | 1.325E−01 | 6.587E−02 | 2.605E−01 | −2.422E−01 | −2.200E−02 |
| D | −5.062E−01 | −3.658E−01 | −1.488E−01 | −5.452E−01 | 4.018E−01 | −1.063E−01 |
| E | 1.145E+00 | 6.904E−01 | 2.920E−01 | 7.467E−01 | −5.118E−01 | 2.020E−01 |
| F | −1.740E+00 | −9.280E−01 | −4.359E−01 | −7.113E−01 | 4.783E−01 | −1.986E−01 |
| G | 1.835E+00 | 9.124E−01 | 4.670E−01 | 4.853E−01 | −3.265E−01 | 1.262E−01 |
| H | −1.368E+00 | −6.635E−01 | −3.564E−01 | −2.403E−01 | 1.629E−01 | −5.525E−02 |
| J | 7.257E−01 | 3.560E−01 | 1.940E−01 | 8.645E−02 | −5.926E−02 | 1.704E−02 |
| L | −2.725E−01 | −1.387E−01 | −7.488E−02 | −2.235E−02 | 1.552E−02 | −3.706E−03 |
| M | 7.074E−02 | 3.807E−02 | 2.001E−02 | 4.041E−03 | −2.849E−03 | 5.567E−04 |
| N | −1.208E−02 | −6.948E−03 | −3.526E−03 | −4.846E−04 | 3.480E−04 | −5.503E−05 |
| O | 1.219E−03 | 7.551E−04 | 3.682E−04 | 3.458E−05 | −2.540E−05 | 3.220E−06 |
| P | −5.520E−05 | −3.689E−05 | −1.726E−05 | −1.109E−06 | 8.383E−07 | −8.446E−08 |

| | S13 | S14 | S15 | S16 | S17 | S18 |
|---|---|---|---|---|---|---|
| K | 1.021E+01 | 5.075E+00 | −6.391E+00 | −1.112E+01 | −9.900E+01 | −1.122E+01 |
| A | 4.499E−02 | 2.791E−02 | 2.315E−02 | 6.094E−02 | −1.665E−01 | −1.140E−01 |
| B | −3.536E−02 | −5.831E−02 | −5.015E−02 | −5.951E−02 | 1.248E−01 | 7.950E−02 |
| C | 1.444E−02 | 7.718E−02 | 4.745E−02 | 4.068E−02 | −6.805E−02 | −3.696E−02 |
| D | 4.589E−03 | −6.725E−02 | −3.183E−02 | −2.328E−02 | 2.663E−02 | 1.179E−02 |
| E | −9.186E−03 | 4.137E−02 | 1.363E−02 | 1.015E−02 | −7.340E−03 | −2.662E−03 |
| F | 3.968E−03 | −1.889E−02 | −3.393E−03 | −3.272E−03 | 1.428E−03 | 4.341E−04 |
| G | −5.127E−05 | 6.432E−03 | 2.587E−04 | 7.745E−04 | −1.981E−04 | −5.205E−05 |
| H | −6.283E−04 | −1.616E−03 | 1.273E−04 | −1.342E−04 | 1.974E−05 | 4.631E−06 |
| J | 3.001E−04 | 2.958E−04 | −5.188E−05 | 1.690E−05 | −1.414E−06 | −3.057E−07 |
| L | −7.584E−05 | −3.882E−05 | 9.751E−06 | −1.524E−06 | 7.206E−08 | 1.478E−08 |
| M | 1.190E−05 | 3.553E−06 | −1.095E−06 | 9.572E−08 | −2.542E−09 | −5.075E−10 |
| N | −1.167E−06 | −2.155E−07 | 7.515E−08 | −3.968E−09 | 5.888E−11 | 1.171E−11 |
| O | 6.578E−08 | 7.790E−09 | −2.915E−09 | 9.747E−11 | −8.024E−13 | −1.625E−13 |
| P | −1.631E−09 | −1.271E−10 | 4.918E−11 | −1.074E−12 | 4.854E−15 | 1.024E−15 |

The optical imaging system configured as described above may have the aberration properties illustrated in FIG. 6.

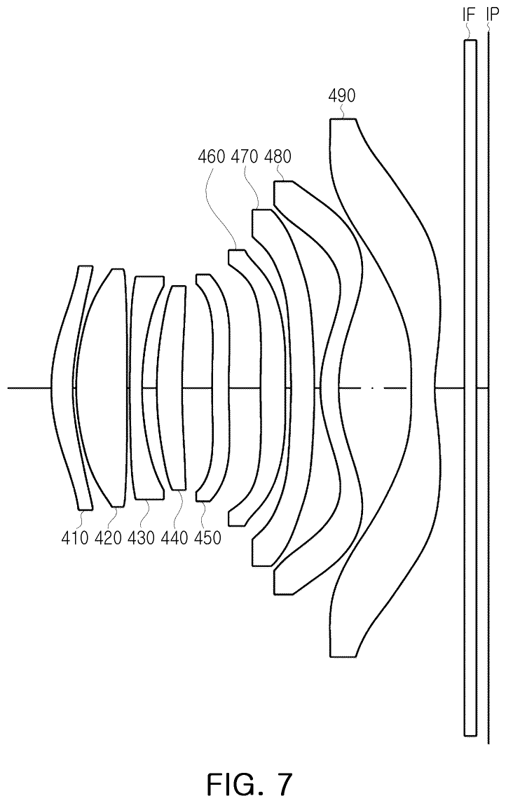

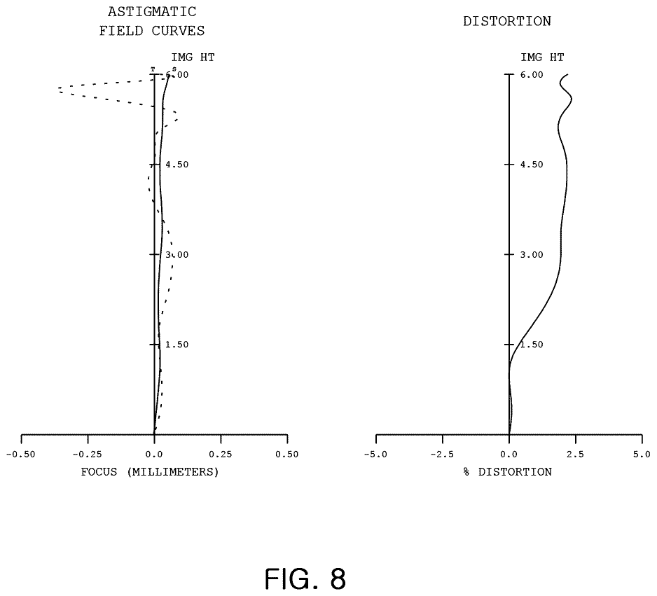

FIG. 7 is a configuration diagram illustrating an optical imaging system according to a fourth embodiment, and FIG. 8 is graphs illustrating aberration properties of the optical imaging system illustrated in FIG. 7.

Referring to FIG. 7, the optical imaging system according to the fourth embodiment may include a first lens 410, a second lens 420, a third lens 430, a fourth lens 440, a fifth lens 450, a sixth lens 460, a seventh lens 470, an eighth lens 480, and a ninth lens 490 sequentially disposed in ascending numerical order along an optical axis of the optical imaging system from an object side of the optical imaging system toward an imaging plane IP of the optical imaging system, and may further include a filter IF disposed between the ninth lens 490 and the imaging place IP.

The optical imaging system according to the fourth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 7 below.

TABLE 7

| Surface | | Radius of | Thickness or | Refractive | Abbe |
|---|---|---|---|---|---|
| No. | Element | Curvature | Distance | Index | Number |
| S1 | First | 2.888 | 0.368 | 1.544 | 56.0 |
| S2 | Lens | 3.522 | 0.059 | | |
| S3 | Second | 3.604 | 0.871 | 1.544 | 56.0 |
| S4 | Lens | 1145.936 | 0.049 | | |
| S5 | Third | 21.479 | 0.210 | 1.639 | 23.5 |
| S6 | Lens | 4.483 | 0.252 | | |
| S7 | Fourth | 5.667 | 0.436 | 1.544 | 56.0 |
| S8 | Lens | 12.980 | 0.514 | | |
| S9 | Fifth | 11.874 | 0.285 | 1.671 | 19.2 |
| S10 | Lens | 10.614 | 0.546 | | |
| S11 | Sixth | 11.546 | 0.425 | 1.544 | 56.0 |
| S12 | Lens | 18.041 | 0.099 | | |
| S13 | Seventh | −9.523 | 0.401 | 1.614 | 25.9 |
| S14 | Lens | −10.249 | 0.102 | | |
| S15 | Eighth | 2.011 | 0.313 | 1.544 | 56.0 |
| S16 | Lens | 2.655 | 1.247 | | |
| S17 | Ninth | −86.513 | 0.400 | 1.535 | 55.7 |
| S18 | Lens | 2.642 | 0.509 | | |
| S19 | Filter | Infinity | 0.210 | 1.517 | 64.2 |
| S20 | | Infinity | 0.205 | | |
| S21 | Imaging | Infinity | | | |
| | Plane | | | | |

In the fourth embodiment, the first lens 410 may have a positive refractive power, an object-side surface of the first lens 410 may be convex in a paraxial region thereof, and an image-side surface of the first lens 410 may be concave in a paraxial region thereof.

The second lens 420 may have a positive refractive power, an object-side surface of the second lens 420 may be convex in a paraxial region thereof, and an image-side surface of the second lens 420 may be concave in a paraxial region thereof.

The third lens 430 may have a negative refractive power, an object-side surface of the third lens 430 may be convex in a paraxial region thereof, and an image-side surface of the third lens 430 may be concave in a paraxial region thereof.

The fourth lens 440 may have a positive refractive power, an object-side surface of the fourth lens 440 may be convex in a paraxial region thereof, and an image-side surface of the fourth lens 440 may be concave in a paraxial region thereof.

The fifth lens 450 may have a negative refractive power, an object-side surface of the fifth lens 450 may be convex in a paraxial region thereof, and an image-side surface of the fifth lens 450 may be concave in a paraxial region thereof.

The sixth lens 460 may have a positive refractive power, an object-side surface of the sixth lens 460 may be convex in a paraxial region thereof, and an image-side surface of the sixth lens 460 may be concave in a paraxial region thereof.

The seventh lens 470 may have a negative refractive power, an object-side surface of the seventh lens 470 may be concave in a paraxial region thereof, and an image-side surface of the seventh lens 470 may be convex in a paraxial region thereof.

The eighth lens 480 may have a positive refractive power, an object-side surface of the eighth lens 480 may be convex in a paraxial region thereof, and an image-side surface of the eighth lens 480 may be concave in a paraxial region thereof.

The ninth lens 490 may have a negative refractive power, and an object-side surface and an image-side surface of the ninth lens 490 may be concave in respective paraxial regions thereof.

Also, any one or any combination of any two or more of the fifth lens 450, the sixth lens 460, the eighth lens 480, and the ninth lens 490 may have at least one inflection point on at either one or both of the object-side surface and the image-side surface.

Each surface of each of the first lens 410 to the ninth lens 490 may have aspherical coefficients as listed in Table 8 below. For example, the object-side surface and the image-side surface of each of the first lens 410 to the ninth lens 490 may be aspherical.

TABLE 8

| | S1 | S2 | S3 | S4 | S5 | S6 |
|---|---|---|---|---|---|---|
| K | −5.994E+00 | −1.296E+01 | −3.599E+00 | 9.900E+01 | 1.540E+01 | 4.517E+00 |
| A | 1.890E−02 | 2.690E−02 | 6.979E−03 | 1.323E−02 | −1.480E−03 | −1.988E−02 |
| B | 1.140E−02 | −1.179E−01 | −7.180E−02 | −8.996E−02 | −5.009E−02 | 2.912E−02 |
| C | −9.408E−02 | 3.199E−01 | 1.975E−01 | 2.922E−01 | 2.453E−01 | −1.536E−02 |
| D | 2.376E−01 | −5.885E−01 | −3.075E−01 | −6.214E−01 | −7.091E−01 | −2.523E−01 |
| E | −3.693E−01 | 7.378E−01 | 2.963E−01 | 8.902E−01 | 1.297E+00 | 9.650E−01 |
| F | 3.852E−01 | −6.474E−01 | −1.657E−01 | −8.877E−01 | −1.584E+00 | −1.813E+00 |
| G | −2.808E−01 | 4.059E−01 | 3.304E−02 | 6.321E−01 | 1.343E+00 | 2.136E+00 |
| H | 1.459E−01 | −1.835E−01 | 2.390E−02 | −3.261E−01 | −8.096E−01 | −1.701E+00 |
| J | −5.428E−02 | 5.977E−02 | −2.341E−02 | 1.221E−01 | 3.500E−01 | 9.430E−01 |
| L | 1.433E−02 | −1.386E−02 | 9.982E−03 | −3.289E−02 | −1.078E−01 | −3.650E−01 |
| M | −2.621E−03 | 2.227E−03 | −2.537E−03 | 6.204E−03 | 2.308E−02 | 9.686E−02 |
| N | 3.153E−04 | −2.348E−04 | 3.952E−04 | −7.772E−04 | −3.268E−03 | −1.681E−02 |
| O | −2.244E−05 | 1.456E−05 | −3.496E−05 | 5.805E−05 | 2.749E−04 | 1.720E−03 |
| P | 7.158E−07 | −4.007E−07 | 1.350E−06 | −1.954E−06 | −1.040E−05 | −7.870E−05 |

| | S7 | S8 | S9 | S10 | S11 | S12 |
|---|---|---|---|---|---|---|
| K | −5.417E+00 | −9.370E+01 | −8.467E+01 | −9.562E+01 | −4.931E+01 | 2.726E+01 |
| A | 1.053E−02 | −2.322E−03 | −3.955E−02 | −3.672E−02 | −7.435E−02 | −1.247E−01 |
| B | −7.741E−02 | 1.595E−02 | 3.505E−02 | 5.209E−04 | 6.185E−02 | 1.185E−01 |
| C | 3.434E−01 | −6.747E−02 | −8.298E−02 | 7.739E−02 | −3.662E−02 | −8.977E−02 |
| D | −1.003E+00 | 1.736E−01 | 1.747E−01 | −2.448E−01 | −1.465E−02 | 1.345E−02 |
| E | 1.979E+00 | −3.098E−01 | −3.091E−01 | 4.198E−01 | 6.495E−02 | 7.714E−02 |
| F | −2.719E+00 | 3.874E−01 | 4.193E−01 | −4.730E−01 | −8.125E−02 | −1.152E−01 |
| G | 2.657E+00 | −3.414E−01 | −4.209E−01 | 3.718E−01 | 6.187E−02 | 8.873E−02 |
| H | −1.868E+00 | 2.118E−01 | 3.087E−01 | −2.089E−01 | −3.216E−02 | −4.357E−02 |
| J | 9.467E−01 | −9.150E−02 | −1.642E−01 | 8.432E−02 | 1.180E−02 | 1.448E−02 |
| L | −3.423E−01 | 2.684E−02 | 6.239E−02 | −2.425E−02 | −3.060E−03 | −3.307E−03 |
| M | 8.605E−02 | −5.071E−03 | −1.648E−02 | 4.841E−03 | 5.501E−04 | 5.129E−04 |
| N | −1.429E−02 | 5.499E−04 | 2.871E−03 | −6.365E−04 | −6.517E−05 | −5.170E−05 |
| O | 1.408E−03 | −2.468E−05 | −2.961E−04 | 4.946E−05 | 4.573E−06 | 3.057E−06 |
| P | −6.233E−05 | −2.182E−07 | 1.367E−05 | −1.717E−06 | −1.439E−07 | −8.056E−08 |

| | S13 | S14 | S15 | S16 | S17 | S18 |
|---|---|---|---|---|---|---|
| K | 1.010E+01 | 4.372E+00 | −6.154E+00 | −1.095E+01 | −9.900E+01 | −1.012E+01 |
| A | 3.199E−02 | 4.026E−02 | 2.189E−02 | 4.930E−02 | −1.618E−01 | −1.184E−01 |
| B | −1.210E−02 | −5.748E−02 | −4.209E−02 | −3.155E−02 | 1.192E−01 | 8.369E−02 |
| C | −3.406E−02 | 4.288E−02 | 3.940E−02 | 1.118E−02 | −6.235E−02 | −3.938E−02 |
| D | 7.659E−02 | −9.577E−03 | −2.978E−02 | −4.107E−03 | 2.318E−02 | 1.276E−02 |
| E | −7.407E−02 | −9.939E−03 | 1.585E−02 | 1.463E−03 | −6.054E−03 | −2.940E−03 |
| F | 3.980E−02 | 1.007E−02 | −5.953E−03 | −4.044E−04 | 1.115E−03 | 4.921E−04 |
| G | −1.215E−02 | −4.624E−03 | 1.585E−03 | 7.680E−05 | −1.459E−04 | −6.075E−05 |
| H | 1.637E−03 | 1.327E−03 | −2.971E−04 | −9.034E−06 | 1.364E−05 | 5.573E−06 |
| J | 2.024E−04 | −2.569E−04 | 3.845E−05 | 4.622E−07 | −9.093E−07 | −3.790E−07 |
| L | −1.346E−04 | 3.421E−05 | −3.291E−06 | 3.207E−08 | 4.261E−08 | 1.881E−08 |
| M | 2.745E−05 | −3.095E−06 | 1.683E−07 | −7.476E−09 | −1.360E−09 | −6.612E−10 |
| N | −3.013E−06 | 1.818E−07 | −3.638E−09 | 5.719E−10 | 2.778E−11 | 1.554E−11 |
| O | 1.784E−07 | −6.258E−09 | −5.802E−11 | −2.139E−11 | −3.207E−13 | −2.186E−13 |
| P | −4.493E−09 | 9.579E−11 | 3.341E−12 | 3.269E−13 | 1.524E−15 | 1.388E−15 |

The optical imaging system configured as described above may have the aberration properties illustrated in FIG. 8.

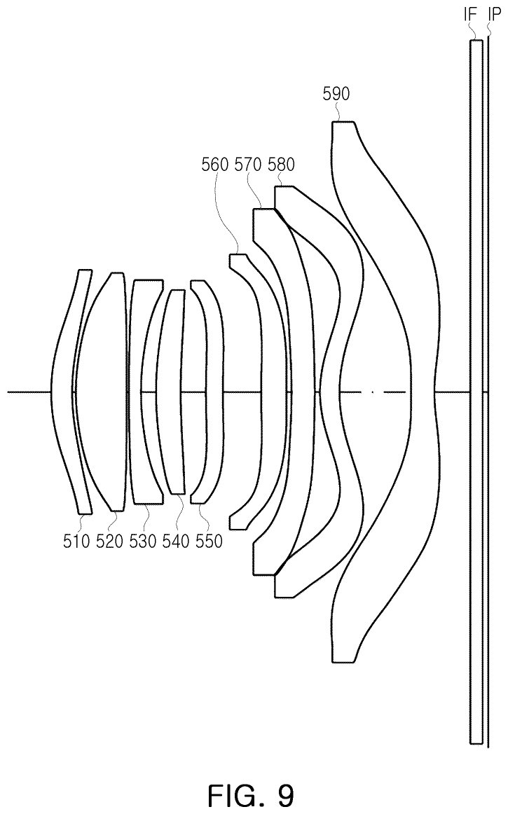

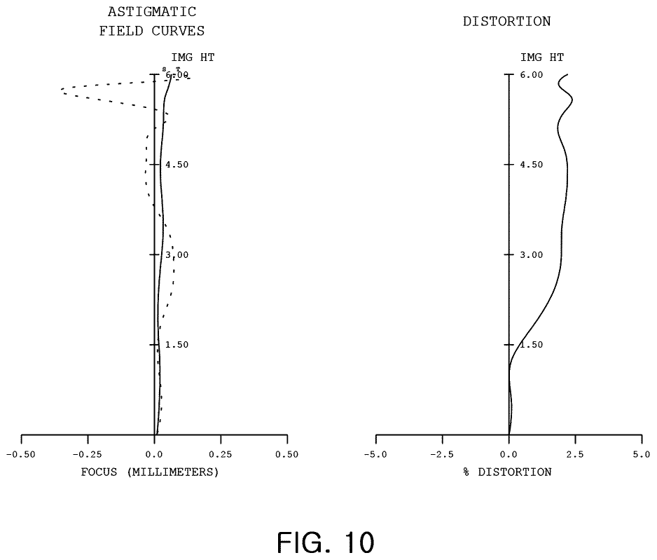

FIG. 9 is a configuration diagram illustrating an optical imaging system according to a fifth embodiment, and FIG. 10 is graphs illustrating aberration properties of the optical imaging system illustrated in FIG. 9.

Referring to FIG. 9. the optical imaging system according to the fifth embodiment may include a first lens 510, a second lens 520, a third lens 530, a fourth lens 540, a fifth lens 550, a sixth lens 560, a seventh lens 570, an eighth lens 580, and a ninth lens 590 sequentially disposed in ascending numerical order along an optical axis of the optical imaging system from an object side of the optical imaging system toward an imaging plane IP of the optical imaging system, and may further include a filter IF disposed between the ninth lens 590 and the imaging plane IP.

The optical imaging system according to the fifth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 9 below.

TABLE 9

| Surface | | Radius of | Thickness or | Refractive | Abbe |
|---|---|---|---|---|---|
| No. | Element | Curvature | Distance | Index | Number |
| S1 | First | 2.869 | 0.360 | 1.544 | 56.0 |
| S2 | Lens | 3.497 | 0.064 | | |
| S3 | Second | 3.608 | 0.872 | 1.544 | 56.0 |
| S4 | Lens | −2186.087 | 0.036 | | |
| S5 | Third | 22.111 | 0.210 | 1.639 | 23.5 |
| S6 | Lens | 4.483 | 0.258 | | |
| S7 | Fourth | 5.667 | 0.423 | 1.544 | 56.0 |
| S8 | Lens | 11.180 | 0.434 | | |
| S9 | Fifth | 11.556 | 0.290 | 1.671 | 19.2 |
| S10 | Lens | 13.066 | 0.658 | | |
| S11 | Sixth | 12.500 | 0.435 | 1.544 | 56.0 |
| S12 | Lens | 20.007 | 0.086 | | |
| S13 | Seventh | −9.569 | 0.397 | 1.614 | 25.9 |
| S14 | Lens | −12.762 | 0.090 | | |
| S15 | Eighth | 1.946 | 0.336 | 1.544 | 56.0 |
| S16 | Lens | 2.543 | 1.228 | | |
| S17 | Ninth | −110.978 | 0.400 | 1.535 | 55.7 |
| S18 | Lens | 2.725 | 0.615 | | |
| S19 | Filter | Infinity | 0.210 | 1.517 | 64.2 |
| S20 | | Infinity | 0.100 | | |
| S21 | Imaging | Infinity | | | |
| | Plane | | | | |

In the fifth embodiment, the first lens 510 may have a positive refractive power, an object-side surface of the first lens 510 may be convex in a paraxial region thereof, and an image-side surface of the first lens 510 may be concave in a paraxial region thereof.

The second lens 520 may have a positive refractive power, and an object-side surface and an image-side surface of the second lens 520 may be convex in respective paraxial regions thereof.

The third lens 530 may have a negative refractive power, an object-side surface of the third lens 530 may be convex in a paraxial region thereof, and an image-side surface of the third lens 530 may be concave in a paraxial region thereof.

The fourth lens 540 may have a positive refractive power, an object-side surface of the fourth lens 540 may be convex in a paraxial region thereof, and an image-side surface of the fourth lens 540 may be concave in a paraxial region thereof.

The fifth lens 550 may have a positive refractive power, an object-side surface of the fifth lens 550 may be convex in a paraxial region thereof, and an image-side surface of the fifth lens 550 may be concave in a paraxial region thereof.

The sixth lens 560 may have a positive refractive power, an object-side surface of the sixth lens 560 may be convex in a paraxial region thereof, and an image-side surface of the sixth lens 560 may be concave in a paraxial region thereof.

The seventh lens 570 may have a negative refractive power, an object-side surface of the seventh lens 570 may be concave in a paraxial region thereof, and an image-side surface of the seventh lens 570 may be convex in a paraxial region thereof.

The eighth lens 580 may have a positive refractive power, an object-side surface of the eighth lens 580 may be convex in a paraxial region thereof, and an image-side surface of the eighth lens 580 may be concave in a paraxial region thereof.

The ninth lens 590 may have a negative refractive power, and an object-side surface and an image-side surface of the ninth lens 590 may be concave in respective paraxial regions thereof.

Also, any one or any combination of any two or more of the fifth lens 550, the sixth lens 560, the eighth lens 580, and the ninth lens 590 may have at least one inflection point on at either one or both of the object-side surface and the image-side surface.

Each surface of each of the first lens 510 to the ninth lens 590 may have aspherical coefficients as listed in Table 10 below. For example, the object-side surface and the image-side surface of each of the first lens 510 to the ninth lens 590 may be aspherical.

TABLE 10

| | S1 | S2 | S3 | S4 | S5 | S6 |
|---|---|---|---|---|---|---|
| K | −5.994E+00 | −1.347E+01 | −3.694E+00 | −9.900E+01 | 1.540E+01 | 4.517E+00 |
| A | 1.977E−02 | 2.568E−02 | 6.525E−03 | 1.349E−02 | −2.954E−03 | −2.113E−02 |
| B | 7.576E−03 | −1.029E−01 | −6.843E−02 | −9.691E−02 | −4.290E−02 | 3.702E−02 |
| C | −8.251E−02 | 2.478E−01 | 1.649E−01 | 3.395E−01 | 2.590E−01 | −8.797E−03 |
| D | 2.126E−01 | −4.054E−01 | −1.983E−01 | −7.702E−01 | −8.184E−01 | −3.358E−01 |
| E | −3.309E−01 | 4.514E−01 | 9.787E−02 | 1.156E+00 | 1.545E+00 | 1.175E+00 |
| F | 3.435E−01 | −3.490E−01 | 6.238E−02 | −1.191E+00 | −1.902E+00 | −2.105E+00 |
| G | −2.489E−01 | 1.897E−01 | −1.448E−01 | 8.691E−01 | 1.609E+00 | 2.396E+00 |
| H | 1.285E−01 | −7.212E−02 | 1.212E−01 | −4.565E−01 | −9.638E−01 | −1.857E+00 |
| J | −4.751E−02 | 1.871E−02 | −6.123E−02 | 1.734E−01 | 4.127E−01 | 1.006E+00 |
| L | 1.248E−02 | −3.094E−03 | 2.040E−02 | −4.721E−02 | −1.257E−01 | −3.813E−01 |
| M | −2.271E−03 | 2.657E−04 | −4.525E−03 | 8.981E−03 | 2.660E−02 | 9.933E−02 |
| N | 2.722E−04 | 1.037E−06 | 6.453E−04 | −1.133E−03 | −3.719E−03 | −1.695E−02 |
| O | −1.932E−05 | −2.273E−06 | −5.365E−05 | 8.506E−05 | 3.087E−04 | 1.707E−03 |
| P | 6.147E−07 | 1.395E−07 | 1.979E−06 | −2.877E−06 | −1.152E−05 | −7.691E−05 |

| | S7 | S8 | S9 | S10 | S11 | S12 |
|---|---|---|---|---|---|---|
| K | −6.121E+00 | −9.900E+01 | −8.467E+01 | −9.900E+01 | −2.038E+01 | 3.740E+01 |
| A | 6.339E−03 | −6.408E−03 | −3.827E−02 | −3.712E−02 | −6.411E−02 | −1.388E−01 |
| B | −5.905E−02 | 3.359E−02 | 1.535E−02 | −9.932E−04 | 4.681E−02 | 1.391E−01 |
| C | 2.756E−01 | −1.269E−01 | 4.043E−02 | 8.367E−02 | −7.915E−03 | −8.298E−02 |
| D | −8.168E−01 | 3.151E−01 | −2.645E−01 | −2.766E−01 | −6.174E−02 | −2.346E−02 |
| E | 1.624E+00 | −5.447E−01 | 6.798E−01 | 5.060E−01 | 1.192E−01 | 1.168E−01 |
| F | −2.246E+00 | 6.652E−01 | −1.077E+00 | −6.100E−01 | −1.251E−01 | −1.378E−01 |
| G | 2.209E+00 | −5.804E−01 | 1.156E+00 | 5.130E−01 | 8.724E−02 | 9.557E−02 |
| H | −1.562E+00 | 3.632E−01 | −8.728E−01 | −3.080E−01 | −4.300E−02 | −4.385E−02 |
| J | 7.956E−01 | −1.623E−01 | 4.686E−01 | 1.328E−01 | 1.530E−02 | 1.384E−02 |
| L | −2.888E−01 | 5.102E−02 | −1.782E−01 | −4.077E−02 | −3.923E−03 | −3.025E−03 |
| M | 7.284E−02 | −1.094E−02 | 4.692E−02 | 8.691E−03 | 7.092E−04 | 4.514E−04 |
| N | −1.212E−02 | 1.508E−03 | −8.139E−03 | −1.221E−03 | −8.587E−05 | −4.393E−05 |
| O | 1.196E−03 | −1.190E−04 | 8.373E−04 | 1.017E−04 | 6.248E−06 | 2.515E−06 |
| P | −5.301E−05 | 4.003E−06 | −3.872E−05 | −3.793E−06 | −2.063E−07 | −6.433E−08 |

| | S13 | S14 | S15 | S16 | S17 | S18 |
|---|---|---|---|---|---|---|
| K | 1.011E+01 | 5.024E+00 | −5.907E+00 | −1.070E+01 | −9.900E+01 | −1.037E+01 |
| A | 1.848E−02 | 5.369E−02 | 3.001E−02 | 5.092E−02 | −1.653E−01 | −1.240E−01 |
| B | 2.761E−03 | −8.402E−02 | −5.452E−02 | −2.461E−02 | 1.260E−01 | 8.996E−02 |
| C | −2.118E−02 | 7.483E−02 | 5.152E−02 | −3.205E−03 | −6.854E−02 | −4.354E−02 |
| D | 3.253E−02 | −3.662E−02 | −4.127E−02 | 7.749E−03 | 2.645E−02 | 1.448E−02 |
| E | −2.253E−02 | 6.599E−03 | 2.412E−02 | −4.402E−03 | −7.152E−03 | −3.420E−03 |
| F | 2.454E−03 | 2.681E−03 | −1.007E−02 | 1.568E−03 | 1.361E−03 | 5.853E−04 |
| G | 6.543E−03 | −2.190E−03 | 3.010E−03 | −3.981E−04 | −1.841E−04 | −7.375E−05 |
| H | −5.031E−03 | 7.347E−04 | −6.444E−04 | 7.461E−05 | 1.787E−05 | 6.894E−06 |
| J | 1.907E−03 | −1.513E−04 | 9.842E−05 | −1.035E−05 | −1.245E−06 | −4.771E−07 |
| L | −4.438E−04 | 2.063E−05 | −1.057E−05 | 1.048E−06 | 6.163E−08 | 2.409E−08 |
| M | 6.627E−05 | −1.875E−06 | 7.757E−07 | −7.481E−08 | −2.112E−09 | −8.603E−10 |
| N | −6.218E−06 | 1.095E−07 | −3.669E−08 | 3.557E−09 | 4.750E−11 | 2.054E−11 |
| O | 3.350E−07 | −3.721E−09 | 9.966E−10 | −1.007E−10 | −6.290E−13 | −2.935E−13 |
| P | −7.918E−09 | 5.600E−11 | −1.160E−11 | 1.281E−12 | 3.702E−15 | 1.894E−15 |

The optical imaging system configured as described above may have the aberration properties illustrated in FIG. 10.

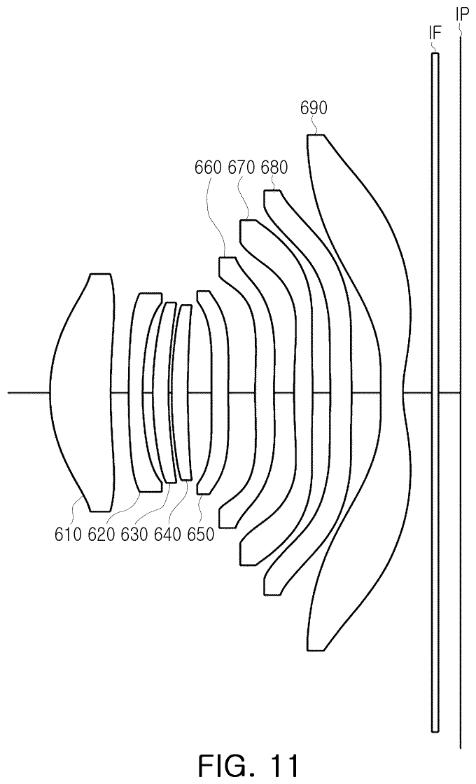

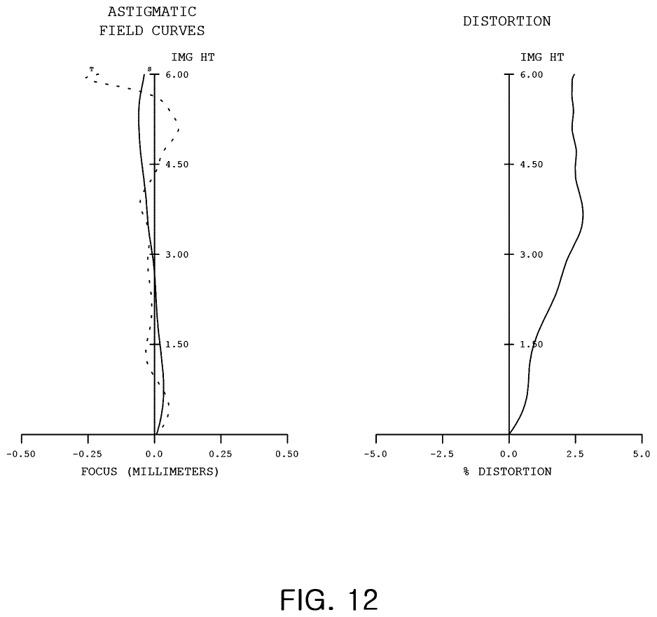

FIG. 11 is a configuration diagram illustrating an optical imaging system according to a sixth embodiment, and FIG. 12 is graphs illustrating aberration properties of the optical imaging system illustrated in FIG. 11.

Referring to FIG. 11, the optical imaging system according to the sixth embodiment may include a first lens 610, a second lens 620, a third lens 630, a fourth lens 640, a fifth lens 650, a sixth lens 660, a seventh lens 670, an eighth lens 680, and a ninth lens 690 sequentially disposed in ascending numerical order along an optical axis of the optical imaging system from an object side of the optical imaging system toward an imaging plane IP of the optical imaging system, and may further include a filter IF disposed between the ninth lens 690 and the imaging plane IP.

The optical imaging system according to the sixth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 11 below.

TABLE 11

| Surface | | Radius of | Thickness or | Refractive | Abbe |
|---|---|---|---|---|---|
| No. | Element | Curvature | Distance | Index | Number |
| S1 | First | 2.580 | 1.043 | 1.544 | 56.0 |
| S2 | Lens | 9.822 | 0.310 | | |
| S3 | Second | 14.072 | 0.240 | 1.680 | 18.2 |
| S4 | Lens | 5.595 | 0.175 | | |
| S5 | Third | 5.770 | 0.271 | 1.544 | 56.0 |
| S6 | Lens | 7.676 | 0.053 | | |
| S7 | Fourth | 7.339 | 0.276 | 1.544 | 56.0 |
| S8 | Lens | 15.719 | 0.409 | | |
| S9 | Fifth | 42.735 | 0.288 | 1.680 | 18.2 |
| S10 | Lens | 24.296 | 0.460 | | |
| S11 | Sixth | 7.721 | 0.326 | 1.567 | 37.4 |
| S12 | Lens | 7.406 | 0.343 | | |
| S13 | Seventh | 12.121 | 0.321 | 1.544 | 56.0 |
| S14 | Lens | −7.243 | 0.303 | | |
| S15 | Eighth | −6.834 | 0.366 | 1.567 | 37.4 |
| S16 | Lens | −7.921 | 0.499 | | |
| S17 | Ninth | 19.164 | 0.380 | 1.535 | 55.7 |
| S18 | Lens | 1.821 | 0.500 | | |
| S19 | Filter | Infinity | 0.110 | 1.517 | 64.2 |
| S20 | | Infinity | 0.379 | | |
| S21 | Imaging | Infinity | | | |
| | Plane | | | | |

In the sixth embodiment, the first lens 610 may have a positive refractive power, an object-side surface of the first lens 610 may be convex in a paraxial region thereof, and an image-side surface of the first lens 610 may be concave in a paraxial region thereof.

The second lens 620 may have a negative refractive power, an object-side surface of the second lens 620 may be convex in a paraxial region thereof, and an image-side surface of the second lens 620 may be concave in a paraxial region thereof.

The third lens 630 may have a positive refractive power, an object-side surface of the third lens 630 may be convex in a paraxial region thereof, and an image-side surface of the third lens 630 may be concave in a paraxial region thereof.

The fourth lens 640 may have a positive refractive power, an object-side surface of the fourth lens 640 may be convex in a paraxial region thereof, and an image-side surface of the fourth lens 640 may be concave in a paraxial region thereof.

The fifth lens 650 may have a negative refractive power, an object-side surface of the fifth lens 650 may be convex in a paraxial region thereof, and an image-side surface of the fifth lens 650 may be concave in a paraxial region thereof.

The sixth lens 660 may have a negative refractive power, an object-side surface of the sixth lens 660 may be convex in a paraxial region thereof, and an image-side surface of the sixth lens 660 may be concave in a paraxial region thereof.

The seventh lens 670 may have a positive refractive power, and an object-side surface and an image-side surface of the seventh lens 670 may be convex in respective paraxial regions thereof.

The eighth lens 680 may have a negative refractive power, an object-side surface of the eighth lens 680 may be concave in a paraxial region thereof, and an image-side surface of the eighth lens 680 may be convex in a paraxial region thereof.

The ninth lens 690 may have a negative refractive power, an object-side surface of the ninth lens 690 may be convex in a paraxial region thereof, and an image-side surface of the ninth lens 690 may be concave in a paraxial region thereof.

Also, any one or any combination of any two or more of the fifth lens 650, the sixth lens 660, the eighth lens 680, and the ninth lens 690 may have at least one inflection point on either one or both of the object-side surface and the image-side surface.

Each surface of each of the first lens 610 to the ninth lens 690 may have aspherical coefficients as listed in Table 12 below. For example, the object-side surface and the image-side surface of each of the first lens 610 to the ninth lens 690 may be aspherical.

TABLE 12

| | S1 | S2 | S3 | S4 | S5 | S6 |
|---|---|---|---|---|---|---|
| K | −1.991E+00 | −4.947E+01 | 4.712E+01 | 1.208E+01 | 8.081E+00 | −5.086E+00 |
| A | 1.744E−02 | −6.215E−03 | −1.630E−02 | 8.802E−03 | 3.065E−02 | 1.228E−02 |
| B | −3.296E−02 | 2.680E−02 | 7.890E−02 | −2.924E−01 | −2.727E−01 | 4.163E−02 |
| C | 9.916E−02 | −1.196E−01 | −4.004E−01 | 2.414E+00 | 1.198E+00 | −6.019E−01 |
| D | −1.941E−01 | 3.056E−01 | 1.365E+00 | −1.137E+01 | −3.409E+00 | 2.722E+00 |
| E | 2.525E−01 | −5.159E−01 | −3.084E+00 | 3.397E+01 | 6.314E+00 | −7.404E+00 |
| F | −2.273E−01 | 5.989E−01 | 4.821E+00 | −6.816E+01 | −7.604E+00 | 1.349E+01 |
| G | 1.453E−01 | −4.895E−01 | −5.352E+00 | 9.508E+01 | 5.693E+00 | −1.717E+01 |
| H | −6.696E−02 | 2.853E−01 | 4.272E+00 | −9.406E+01 | −2.096E+00 | 1.561E+01 |
| J | 2.235E−02 | −1.189E−01 | −2.454E+00 | 6.642E+01 | −3.920E−01 | −1.021E+01 |
| L | −5.362E−03 | 3.515E−02 | 1.005E+00 | −3.325E+01 | 9.144E−01 | 4.776E+00 |
| M | 9.035E−04 | −7.183E−03 | −2.860E−01 | 1.153E+01 | −5.106E−01 | −1.558E+00 |
| N | −1.017E−04 | 9.651E−04 | 5.367E−02 | −2.631E+00 | 1.512E−01 | 3.372E−01 |
| O | 6.872E−06 | −7.666E−05 | −5.971E−03 | 3.557E−01 | −2.414E−02 | −4.348E−02 |
| P | −2.113E−07 | 2.727E−06 | 2.981E−04 | −2.158E−02 | 1.640E−03 | 2.529E−03 |

| | S7 | S8 | S9 | S10 | S11 | S12 |
|---|---|---|---|---|---|---|
| K | 7.857E−01 | 9.056E+01 | 9.900E+01 | −9.900E+01 | −1.879E+01 | 2.138E+00 |
| A | −3.793E−03 | 6.214E−03 | −5.416E−02 | −5.533E−02 | −9.845E−02 | −1.090E−01 |
| B | 7.746E−02 | −1.802E−01 | 2.553E−01 | 1.102E−01 | 9.140E−02 | −7.777E−03 |
| C | −4.790E−01 | 1.246E+00 | −1.851E+00 | −5.960E−01 | −1.295E−01 | 1.766E−01 |
| D | 1.705E+00 | −5.246E+00 | 7.584E+00 | 2.057E+00 | 2.217E−01 | −3.231E−01 |
| E | −4.322E+00 | 1.462E+01 | −1.978E+01 | −4.588E+00 | −3.199E−01 | 3.410E−01 |
| F | 8.195E+00 | −2.827E+01 | 3.497E+01 | 6.919E+00 | 3.252E−01 | −2.443E−01 |
| G | −1.163E+01 | 3.896E+01 | −4.351E+01 | −7.308E+00 | −2.295E−01 | 1.256E−01 |
| H | 1.220E+01 | −3.879E+01 | 3.884E+01 | 5.513E+00 | 1.139E−01 | −4.746E−02 |
| J | −9.330E+00 | 2.793E+01 | −2.500E+01 | −2.988E+00 | −3.999E−02 | 1.322E−02 |
| L | 5.093E+00 | −1.440E+01 | 1.151E+01 | 1.155E+00 | 9.891E−03 | −2.690E−03 |
| M | −1.925E+00 | 5.175E+00 | −3.700E+00 | −3.106E−01 | −1.681E−03 | 3.889E−04 |
| N | 4.771E−01 | −1.230E+00 | 7.883E−01 | 5.521E−02 | 1.862E−04 | −3.787E−05 |
| O | −6.962E−02 | 1.737E−01 | −1.000E−01 | −5.830E−03 | −1.198E−05 | 2.227E−06 |
| P | 4.529E−03 | −1.102E−02 | 5.725E−03 | 2.768E−04 | 3.338E−07 | −5.970E−08 |

| | S13 | S14 | S15 | S16 | S17 | S18 |
|---|---|---|---|---|---|---|
| K | 4.234E−01 | 9.910E−01 | −3.260E−01 | 5.845E−01 | 6.755E+00 | −6.691E+00 |
| A | 4.385E−02 | 1.820E−01 | 2.103E−01 | 1.531E−01 | −2.252E−01 | −1.775E−01 |
| B | −1.845E−01 | −3.338E−01 | −3.182E−01 | −2.021E−01 | 1.733E−01 | 1.494E−01 |
| C | 2.932E−01 | 4.180E−01 | 3.028E−01 | 1.778E−01 | −8.997E−02 | −8.661E−02 |
| D | −2.826E−01 | −3.427E−01 | −2.097E−01 | −1.167E−01 | 3.171E−02 | 3.480E−02 |
| E | 1.816E−01 | 1.891E−01 | 1.064E−01 | 5.534E−02 | −7.713E−03 | −9.836E−03 |
| F | −8.649E−02 | −7.350E−02 | −3.954E−02 | −1.875E−02 | 1.326E−03 | 1.984E−03 |
| G | 3.291E−02 | 2.078E−02 | 1.079E−02 | 4.563E−03 | −1.639E−04 | −2.888E−04 |
| H | −1.025E−02 | −4.349E−03 | −2.166E−03 | −8.020E−04 | 1.469E−05 | 3.050E−05 |
| J | 2.549E−03 | 6.759E−04 | 3.181E−04 | 1.018E−04 | −9.536E−07 | −2.333E−06 |
| L | −4.817E−04 | −7.719E−05 | −3.371E−05 | −9.239E−06 | 4.421E−08 | 1.278E−07 |
| M | 6.533E−05 | 6.297E−06 | 2.504E−06 | 5.839E−07 | −1.421E−09 | −4.879E−09 |
| N | −5.915E−06 | −3.472E−07 | −1.235E−07 | −2.440E−08 | 2.991E−11 | 1.232E−10 |
| O | 3.178E−07 | 1.158E−08 | 3.627E−09 | 6.058E−10 | −3.681E−13 | −1.850E−12 |
| P | −7.622E−09 | −1.763E−10 | −4.799E−11 | −6.764E−12 | 1.985E−15 | 1.249E−14 |

The optical imaging system configured as described above may have the aberration properties illustrated in FIG. 12.

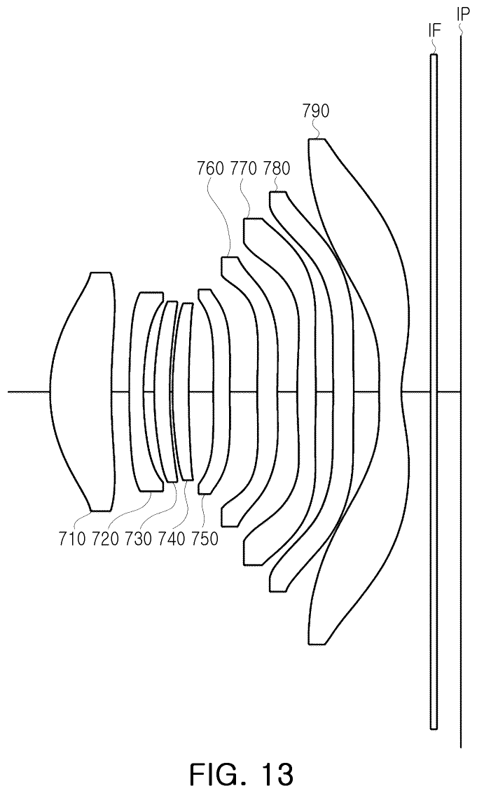

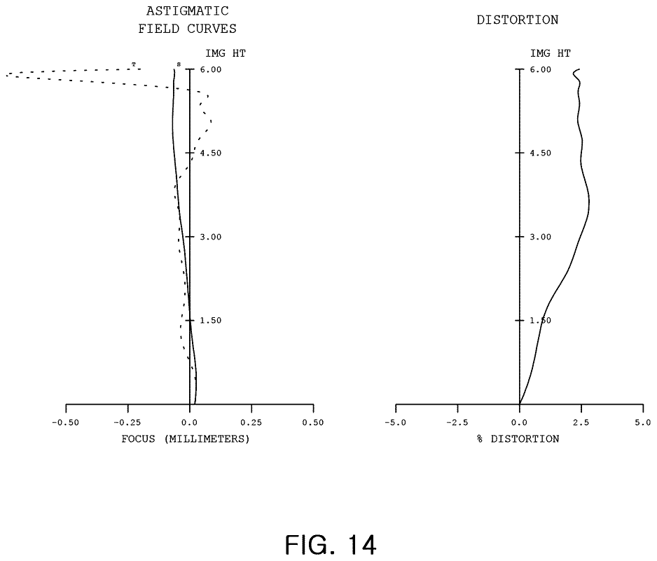

FIG. 13 is a configuration diagram illustrating an optical imaging system according to a seventh embodiment, and FIG. 14 is graphs illustrating aberration properties of the optical imaging system illustrated in FIG. 13.

Referring to FIG. 13, the optical imaging system according to the seventh embodiment may include a first lens 710, a second lens 720, a third lens 730, a fourth lens 740, a fifth lens 750, a sixth lens 760, a seventh lens 770, an eighth lens 780, and a ninth lens 790 sequentially disposed in ascending numerical order along an optical axis of the optical imaging system from an object side of the optical imaging system toward an imaging plane IP of the optical imaging system, and may further include a filter IF disposed between the ninth lens 790 and the imaging plane IP.

The optical imaging system according to the seventh embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 13 below.

TABLE 13

| Surface | | Radius of | Thickness or | Refractive | Abbe |
|---|---|---|---|---|---|
| No. | Element | Curvature | Distance | Index | Number |
| S1 | First | 2.580 | 1.052 | 1.544 | 56.0 |
| S2 | Lens | 9.950 | 0.308 | | |
| S3 | Second | 14.346 | 0.244 | 1.680 | 18.2 |
| S4 | Lens | 5.599 | 0.185 | | |
| S5 | Third | 5.757 | 0.266 | 1.544 | 56.0 |
| S6 | Lens | 7.426 | 0.050 | | |
| S7 | Fourth | 7.109 | 0.277 | 1.544 | 56.0 |
| S8 | Lens | 15.498 | 0.422 | | |
| S9 | Fifth | 37.150 | 0.284 | 1.680 | 18.2 |
| S10 | Lens | 22.657 | 0.469 | | |
| S11 | Sixth | 7.630 | 0.345 | 1.567 | 37.4 |
| S12 | Lens | 7.748 | 0.343 | | |
| S13 | Seventh | 12.863 | 0.320 | 1.544 | 56.0 |
| S14 | Lens | −7.458 | 0.299 | | |
| S15 | Eighth | −7.069 | 0.351 | 1.567 | 37.4 |
| S16 | Lens | −8.247 | 0.438 | | |
| S17 | Ninth | 19.062 | 0.380 | 1.535 | 55.7 |
| S18 | Lens | 1.889 | 0.500 | | |
| S19 | Filter | Infinity | 0.110 | 1.517 | 64.2 |
| S20 | | Infinity | 0.409 | | |
| S21 | Imaging | Infinity | | | |
| | Plane | | | | |

In a seventh embodiment, the first lens 710 may have a positive refractive power, an object-side surface of the first lens 710 may be convex in a paraxial region thereof, and an image-side surface of the first lens 710 may be concave in a paraxial region thereof.

The second lens 720 may have a negative refractive power, an object-side surface of the second lens 720 may be convex in a paraxial region thereof, and an image-side surface of the second lens 720 may be concave in a paraxial region thereof.

The third lens 730 may have a positive refractive power, an object-side surface of the third lens 730 may be convex in a paraxial region thereof, and an image-side surface of the third lens 730 may be concave in a paraxial region thereof.

The fourth lens 740 may have a positive refractive power, an object-side surface of the fourth lens 740 may be convex in a paraxial region thereof, and an image-side surface of the fourth lens 740 may be concave in a paraxial region thereof.

The fifth lens 750 may have a negative refractive power, an object-side surface of the fifth lens 750 may be convex in a paraxial region thereof, and an image-side surface of the fifth lens 750 may be concave in a paraxial region thereof.

The sixth lens 760 may have a positive refractive power, an object-side surface of the sixth lens 760 may be convex in a paraxial region thereof, and an image-side surface of the sixth lens 760 may be concave in a paraxial region thereof.

The seventh lens 770 may have a positive refractive power, and an object-side surface and an image-side surface of the seventh lens 770 may be convex in respective paraxial regions thereof.

The eighth lens 780 may have a negative refractive power, an object-side surface of the eighth lens 780 may be concave in a paraxial region thereof, and an image-side surface of the eighth lens 780 may be convex in a paraxial region thereof.

The ninth lens 790 may have a negative refractive power, an object-side surface of the ninth lens 790 may be convex in a paraxial region thereof, and an image-side surface of the ninth lens 790 may be concave in a paraxial region thereof.

Also, any one or any combination of any two or more of the fifth lens 750, the sixth lens 760, the eighth lens 780, and the ninth lens 790 may have at least one inflection point on either one or both of the object-side surface and the image-side surface.

Each surface of each of the first lens 710 to the ninth lens 790 may have aspherical coefficients as listed in Table 14 below. For example, the object-side surface and the image-side surface of each of the first lens 710 to the ninth lens 790 may be aspherical.

TABLE 14

| | S1 | S2 | S3 | S4 | S5 | S6 |
|---|---|---|---|---|---|---|
| K | −1.963E+00 | −4.963E+01 | 4.705E+01 | 1.207E+01 | 7.998E+00 | −4.880E+00 |
| A | 1.813E−02 | −6.836E−03 | −1.781E−02 | 1.487E−02 | 3.468E−02 | 6.701E−04 |
| B | −3.822E−02 | 3.225E−02 | 8.346E−02 | −3.372E−01 | −3.135E−01 | 1.953E−01 |
| C | 1.169E−01 | −1.384E−01 | −3.528E−01 | 2.559E+00 | 1.424E+00 | −1.526E+00 |
| D | −2.275E−01 | 3.437E−01 | 1.037E+00 | −1.139E+01 | −4.261E+00 | 6.068E+00 |
| E | 2.907E−01 | −5.639E−01 | −2.101E+00 | 3.266E+01 | 8.558E+00 | −1.548E+01 |
| F | −2.548E−01 | 6.369E−01 | 3.038E+00 | −6.354E+01 | −1.181E+01 | 2.715E+01 |
| G | 1.574E−01 | −5.073E−01 | −3.194E+00 | 8.658E+01 | 1.138E+01 | −3.383E+01 |
| H | −6.977E−02 | 2.888E−01 | 2.458E+00 | −8.407E+01 | −7.671E+00 | 3.041E+01 |
| J | 2.230E−02 | −1.177E−01 | −1.379E+00 | 5.848E+01 | 3.563E+00 | −1.981E+01 |
| L | −5.107E−03 | 3.409E−02 | 5.559E−01 | −2.892E+01 | −1.093E+00 | 9.257E+00 |
| M | 8.192E−04 | −6.834E−03 | −1.566E−01 | 9.926E+00 | 1.993E−01 | −3.025E+00 |
| N | −8.761E−05 | 9.019E−04 | 2.924E−02 | −2.247E+00 | −1.467E−02 | 6.561E−01 |
| O | 5.626E−06 | −7.043E−05 | −3.243E−03 | 3.017E−01 | −1.121E−03 | −8.477E−02 |
| P | −1.645E−07 | 2.466E−06 | 1.618E−04 | −1.820E−02 | 2.055E−04 | 4.936E−03 |

| | S7 | S8 | S9 | S10 | S11 | S12 |
|---|---|---|---|---|---|---|
| K | 5.983E−01 | 9.014E+01 | 8.705E+01 | −9.900E+01 | −1.791E+01 | 2.276E+00 |
| A | −7.529E−03 | 1.447E−02 | −3.133E−02 | −5.568E−02 | −1.086E−01 | −1.136E−01 |
| B | 1.469E−01 | −2.202E−01 | −1.635E−02 | 7.681E−02 | 1.782E−01 | 4.038E−02 |
| C | −8.962E−01 | 1.290E+00 | −2.275E−01 | −4.029E−01 | −4.849E−01 | −5.654E−04 |
| D | 3.149E+00 | −4.865E+00 | 1.650E+00 | 1.478E+00 | 1.082E+00 | 2.801E−02 |
| E | −7.651E+00 | 1.246E+01 | −5.361E+00 | −3.469E+00 | −1.680E+00 | −9.118E−02 |
| F | 1.360E+01 | −2.251E+01 | 1.061E+01 | 5.422E+00 | 1.812E+00 | 1.124E−01 |
| G | −1.798E+01 | 2.931E+01 | −1.409E+01 | −5.867E+00 | −1.390E+00 | −8.047E−02 |
| H | 1.767E+01 | −2.781E+01 | 1.310E+01 | 4.499E+00 | 7.695E−01 | 3.780E−02 |
| J | −1.276E+01 | 1.923E+01 | −8.657E+00 | −2.464E+00 | −3.086E−01 | −1.219E−02 |
| L | 6.645E+00 | −9.576E+00 | 4.054E+00 | 9.574E−01 | 8.881E−02 | 2.722E−03 |
| M | −2.415E+00 | 3.341E+00 | −1.316E+00 | −2.579E−01 | −1.786E−02 | −4.143E−04 |
| N | 5.792E−01 | −7.740E−01 | 2.818E−01 | 4.575E−02 | 2.382E−03 | 4.097E−05 |
| O | −8.220E−02 | 1.068E−01 | −3.580E−02 | −4.808E−03 | −1.889E−04 | −2.371E−06 |
| P | 5.221E−03 | −6.643E−03 | 2.044E−03 | 2.267E−04 | 6.738E−06 | 6.085E−08 |

| | S13 | S14 | S15 | S16 | S17 | S18 |
|---|---|---|---|---|---|---|
| K | 2.622E+00 | 6.619E−01 | −4.403E−01 | 5.783E−01 | 8.189E+00 | −6.571E+00 |
| A | 5.670E−02 | 1.969E−01 | 2.339E−01 | 1.716E−01 | −1.925E−01 | −1.627E−01 |
| B | −2.361E−01 | −4.057E−01 | −4.288E−01 | −2.787E−01 | 1.098E−01 | 1.277E−01 |
| C | 3.754E−01 | 5.566E−01 | 5.056E−01 | 2.982E−01 | −3.378E−02 | −7.334E−02 |
| D | −3.478E−01 | −4.904E−01 | −4.109E−01 | −2.204E−01 | 2.857E−03 | 3.025E−02 |
| E | 2.012E−01 | 2.876E−01 | 2.306E−01 | 1.114E−01 | 1.847E−03 | −8.881E−03 |
| F | −7.658E−02 | −1.175E−01 | −9.094E−02 | −3.918E−02 | −8.391E−04 | 1.861E−03 |
| G | 1.963E−02 | 3.439E−02 | 2.564E−02 | 9.786E−03 | 1.826E−04 | −2.808E−04 |
| H | −3.425E−03 | −7.326E−03 | −5.224E−03 | −1.757E−03 | −2.517E−05 | 3.064E−05 |
| J | 4.316E−04 | 1.138E−03 | 7.706E−04 | 2.275E−04 | 2.360E−06 | −2.418E−06 |
| L | −5.099E−05 | −1.275E−04 | −8.144E−05 | −2.104E−05 | −1.530E−07 | 1.364E−07 |
| M | 7.320E−06 | 1.004E−05 | 6.008E−06 | 1.356E−06 | 6.777E−09 | −5.360E−09 |
| N | −9.226E−07 | −5.270E−07 | −2.937E−07 | −5.777E−08 | −1.962E−10 | 1.394E−10 |
| O | 6.871E−08 | 1.655E−08 | 8.542E−09 | 1.463E−09 | 3.349E−12 | −2.155E−12 |
| P | −2.141E−09 | −2.354E−10 | −1.119E−10 | −1.668E−11 | −2.560E−14 | 1.501E−14 |

The optical imaging system configured as described above may have the aberration properties illustrated in FIG. 14.

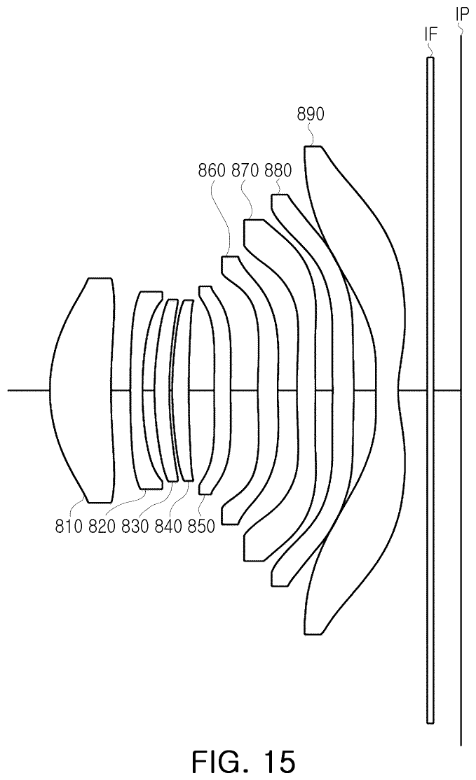

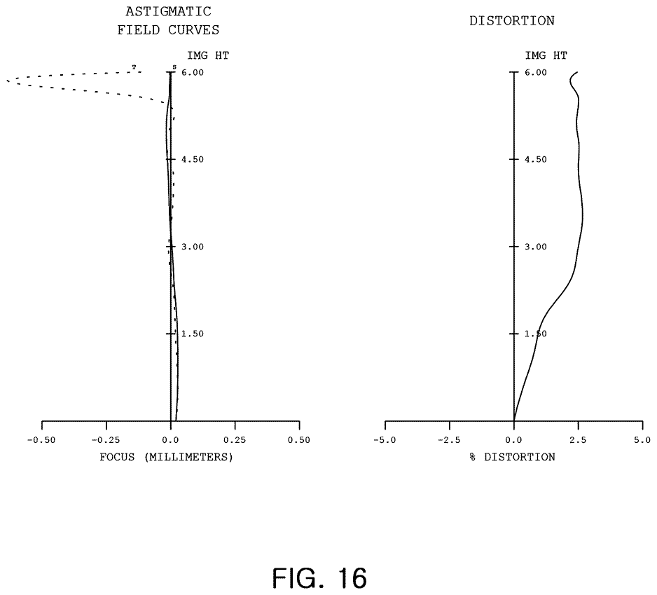

FIG. 15 is a configuration diagram illustrating an optical imaging system according to an eighth embodiment, and FIG. 16 is graphs illustrating aberration properties of the optical imaging system illustrated in FIG. 15.

Referring to FIG. 15, the optical imaging system according to the eighth embodiment may include a first lens 810, a second lens 820, a third lens 830, a fourth lens 840, a fifth lens 850, a sixth lens 860, a seventh lens 870, an eighth lens 880, and a ninth lens 890, sequentially disposed in ascending numerical order along an optical axis of the optical imaging system from an object side of the optical imaging system toward an imaging plane IP of the optical imaging system, and may further include a filter IF disposed between the ninth lens 890 and the imaging plane IP.

The optical imaging system according to the eighth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 15 below.

TABLE 15

| Surface | | Radius of | Thickness or | Refractive | Abbe |
|---|---|---|---|---|---|
| No. | Element | Curvature | Distance | Index | Number |
| S1 | First | 2.581 | 1.049 | 1.544 | 56.0 |
| S2 | Lens | 10.412 | 0.329 | | |
| S3 | Second | 15.360 | 0.209 | 1.680 | 18.2 |
| S4 | Lens | 5.610 | 0.208 | | |
| S5 | Third | 5.717 | 0.254 | 1.544 | 56.0 |
| S6 | Lens | 6.906 | 0.050 | | |
| S7 | Fourth | 6.688 | 0.282 | 1.544 | 56.0 |
| S8 | Lens | 15.398 | 0.437 | | |
| S9 | Fifth | 27.487 | 0.281 | 1.680 | 18.2 |
| S10 | Lens | 19.334 | 0.467 | | |
| S11 | Sixth | 7.199 | 0.343 | 1.567 | 37.4 |
| S12 | Lens | 8.043 | 0.326 | | |
| S13 | Seventh | 14.505 | 0.320 | 1.544 | 56.0 |
| S14 | Lens | −8.649 | 0.293 | | |
| S15 | Eighth | −7.694 | 0.364 | 1.567 | 37.4 |
| S16 | Lens | −7.556 | 0.379 | | |
| S17 | Ninth | 21.144 | 0.380 | 1.535 | 55.7 |
| S18 | Lens | 1.952 | 0.500 | | |
| S19 | Filter | Infinity | 0.110 | 1.517 | 64.2 |
| S20 | | Infinity | 0.468 | | |
| S21 | Imaging | Infinity | | | |
| | Plane | | | | |

In the eighth embodiment, the first lens 810 may have a positive refractive power, an object-side surface of the first lens 810 may be convex in a paraxial region thereof, and an image-side surface of the first lens 810 may be concave in a paraxial region thereof.

The second lens 820 may have negative a refractive power, an object-side surface of the second lens 820 may be convex in a paraxial region thereof, and an image-side surface of the second lens 820 may be concave in a paraxial region thereof.

The third lens 830 may have a positive refractive power, an object-side surface of the third lens 830 may be convex in a paraxial region thereof, and an image-side surface of the third lens 830 may be concave in a paraxial region thereof.

The fourth lens 840 may have a positive refractive power, an object-side surface of the fourth lens 840 may be convex in a paraxial region thereof, and an image-side surface of the fourth lens 840 may be concave in a paraxial region thereof.

The fifth lens 850 may have a negative refractive power, an object-side surface of the fifth lens 850 may be convex in a paraxial region thereof, and an image-side surface of the fifth lens 850 may be concave in a paraxial region thereof.

The sixth lens 860 may have a positive refractive power, an object-side surface of the sixth lens 860 may be convex in a paraxial region thereof, and an image-side surface of the sixth lens 860 may be concave in a paraxial region thereof.

The seventh lens 870 may have a positive refractive power, and an object-side surface and an image-side surface of the seventh lens 870 may be convex in respective paraxial regions thereof.

The eighth lens 880 may have a positive refractive power, an object-side surface of the eighth lens 880 may be concave in a paraxial region thereof, and an image-side surface of the eighth lens 880 may be convex in a paraxial region thereof.

The ninth lens 890 may have a negative refractive power, an object-side surface of the ninth lens 890 may be convex in a paraxial region thereof, and an image-side surface of the ninth lens 890 may be concave in a paraxial region thereof.

Also, any one or any combination of any two or more of the fifth lens 850, the sixth lens 860, the eighth lens 880, and the ninth lens 890 may have at least one inflection point on either one or both of the object-side surface and the image-side surface.

Each surface of each of the first lens 810 to the ninth lens 890 may have aspherical coefficients as listed in Table 16 below. For example, the object-side surface and the image-side surface of each of the first lens 810 to the ninth lens 890 may be aspherical.

TABLE 16

| | S1 | S2 | S3 | S4 | S5 | S6 |
|---|---|---|---|---|---|---|
| K | −1.976E+00 | −5.351E+01 | 5.038E+01 | 1.205E+01 | 7.840E+00 | −3.529E+00 |
| A | 1.350E−02 | −7.411E−03 | −6.525E−03 | −3.032E−03 | 8.493E−03 | 1.849E−02 |
| B | −1.149E−02 | 3.906E−02 | 2.196E−02 | −5.236E−02 | −3.019E−02 | −8.109E−03 |
| C | 3.158E−02 | −1.703E−01 | −1.233E−01 | 5.449E−01 | −1.565E−01 | −1.920E−01 |
| D | −5.859E−02 | 4.377E−01 | 4.138E−01 | −2.971E+00 | 1.230E+00 | 4.377E−01 |
| E | 6.873E−02 | −7.560E−01 | −8.739E−01 | 9.739E+00 | −4.203E+00 | 2.896E−01 |
| F | −5.095E−02 | 9.131E−01 | 1.269E+00 | −2.083E+01 | 8.985E+00 | −3.115E+00 |
| G | 2.223E−02 | −7.886E−01 | −1.311E+00 | 3.053E+01 | −1.310E+01 | 7.052E+00 |
| H | −3.734E−03 | 4.923E−01 | 9.783E−01 | −3.147E+01 | 1.346E+01 | −9.065E+00 |
| J | −1.553E−03 | −2.224E−01 | −5.278E−01 | 2.303E+01 | −9.840E+00 | 7.580E+00 |
| L | 1.197E−03 | 7.191E−02 | 2.037E−01 | −1.191E+01 | 5.082E+00 | −4.275E+00 |
| M | −3.648E−04 | −1.621E−02 | −5.476E−02 | 4.254E+00 | −1.812E+00 | 1.620E+00 |
| N | 6.181E−05 | 2.418E−03 | 9.736E−03 | −9.982E−01 | 4.238E−01 | −3.960E−01 |
| O | −5.704E−06 | −2.143E−04 | −1.029E−03 | 1.385E−01 | −5.850E−02 | 5.656E−02 |
| P | 2.246E−07 | 8.544E−06 | 4.890E−05 | −8.605E−03 | 3.609E−03 | −3.589E−03 |

| | S7 | S8 | S9 | S10 | S11 | S12 |
|---|---|---|---|---|---|---|
| K | −5.345E−01 | 8.958E+01 | 6.108E+01 | −9.900E+01 | −1.935E+01 | 3.021E+00 |
| A | 1.095E−02 | 1.268E−02 | −3.690E−02 | −5.290E−02 | −1.021E−01 | −1.145E−01 |
| B | 2.860E−02 | −1.700E−01 | −4.165E−03 | 4.182E−02 | 1.678E−01 | 9.030E−02 |
| C | −4.288E−01 | 9.225E−01 | −1.386E−02 | −1.199E−01 | −4.538E−01 | −2.095E−01 |
| D | 1.772E+00 | −3.312E+00 | 6.316E−02 | 2.699E−01 | 9.506E−01 | 4.215E−01 |
| E | −4.587E+00 | 8.108E+00 | −9.390E−03 | −3.933E−01 | −1.384E+00 | −5.362E−01 |
| F | 8.392E+00 | −1.406E+01 | −3.981E−01 | 3.211E−01 | 1.420E+00 | 4.492E−01 |
| G | −1.116E+01 | 1.771E+01 | 1.062E+00 | −7.706E−02 | −1.054E+00 | −2.604E−01 |
| H | 1.084E+01 | −1.635E+01 | −1.446E+00 | −1.236E−01 | 5.718E−01 | 1.074E−01 |
| J | −7.644E+00 | 1.106E+01 | 1.232E+00 | 1.577E−01 | −2.269E−01 | −3.184E−02 |
| L | 3.854E+00 | −5.409E+00 | −6.938E−01 | −9.332E−02 | 6.496E−02 | 6.726E−03 |
| M | −1.349E+00 | 1.858E+00 | 2.593E−01 | 3.316E−02 | −1.304E−02 | −9.862E−04 |
| N | 3.108E−01 | −4.246E−01 | −6.202E−02 | −7.231E−03 | 1.735E−03 | 9.510E−05 |
| O | −4.228E−02 | 5.788E−02 | 8.611E−03 | 8.959E−04 | −1.373E−04 | −5.408E−06 |
| P | 2.569E−03 | −3.555E−03 | −5.281E−04 | −4.846E−05 | 4.876E−06 | 1.370E−07 |

| | S13 | S14 | S15 | S16 | S17 | S18 |
|---|---|---|---|---|---|---|
| K | 6.260E+00 | 2.285E+00 | 8.379E−02 | −2.880E−01 | 1.153E+01 | −6.654E+00 |
| A | 7.649E−02 | 2.337E−01 | 2.571E−01 | 1.764E−01 | −1.861E−01 | −1.665E−01 |
| B | −2.716E−01 | −5.034E−01 | −5.275E−01 | −3.262E−01 | 8.853E−02 | 1.366E−01 |
| C | 3.733E−01 | 6.741E−01 | 6.798E−01 | 3.885E−01 | −1.264E−02 | −8.665E−02 |
| D | −3.144E−01 | −5.733E−01 | −5.779E−01 | −3.032E−01 | −8.327E−03 | 4.017E−02 |
| E | 1.913E−01 | 3.260E−01 | 3.309E−01 | 1.567E−01 | 5.509E−03 | −1.317E−02 |
| F | −1.023E−01 | −1.299E−01 | −1.316E−01 | −5.541E−02 | −1.635E−03 | 3.052E−03 |
| G | 5.128E−02 | 3.738E−02 | 3.722E−02 | 1.379E−02 | 3.015E−04 | −5.055E−04 |
| H | −2.159E−02 | −7.878E−03 | −7.595E−03 | −2.453E−03 | −3.758E−05 | 6.038E−05 |
| J | 6.825E−03 | 1.219E−03 | 1.121E−03 | 3.135E−04 | 3.260E−06 | −5.206E−06 |
| L | −1.531E−03 | −1.369E−04 | −1.186E−04 | −2.854E−05 | −1.972E−07 | 3.210E−07 |
| M | 2.343E−04 | 1.085E−05 | 8.762E−06 | 1.806E−06 | 8.153E−09 | −1.379E−08 |
| N | −2.323E−05 | −5.755E−07 | −4.293E−07 | −7.544E−08 | −2.190E−10 | 3.924E−10 |
| O | 1.343E−06 | 1.830E−08 | 1.253E−08 | 1.870E−09 | 3.430E−12 | −6.641E−12 |
| P | −3.436E−08 | −2.633E−10 | −1.648E−10 | −2.081E−11 | −2.360E−14 | 5.063E−14 |

The optical imaging system configured as described above may have the aberration properties illustrated in FIG. 16.

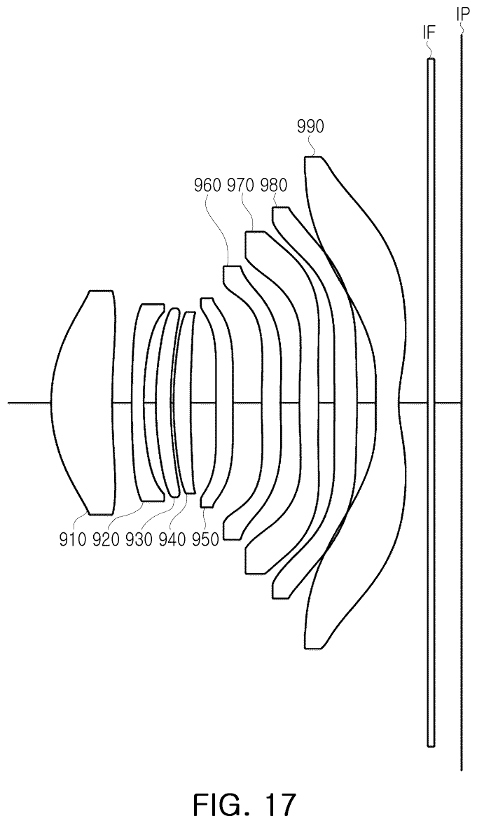

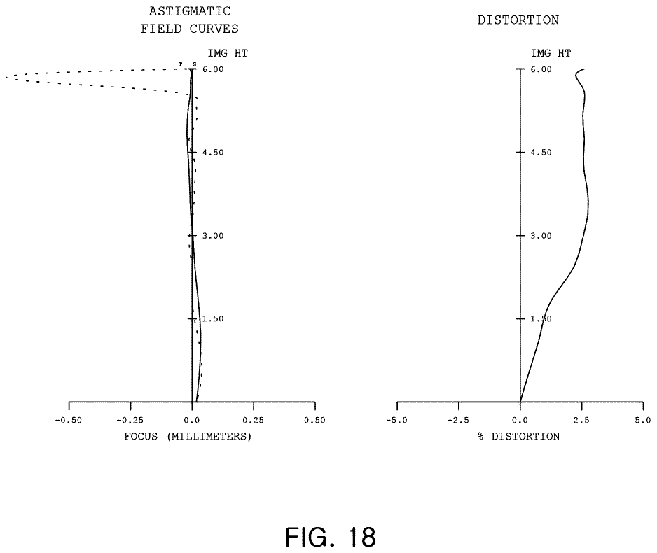

FIG. 17 is a configuration diagram illustrating an optical imaging system according to a ninth embodiment, and FIG. 18 is graphs illustrating aberration properties of the optical imaging system illustrated in FIG. 17.

Referring to FIG. 17, the optical imaging system according to the ninth embodiment may include a first lens 910, a second lens 920, a third lens 930, a fourth lens 940, a fifth lens 950, a sixth lens 960, a seventh lens 970, an eighth lens 980, and a ninth lens 990 sequentially disposed in ascending numerical order along an optical axis of the optical imaging system from an object side of the optical imaging system toward an imaging plane IP of the optical imaging system, and may further include a filter IF disposed between the ninth lens 990 and the imaging plane IP.

The optical imaging system according to the ninth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 17 below.

TABLE 17

| Surface | | Radius of | Thickness or | Refractive | Abbe |
|---|---|---|---|---|---|
| No. | Element | Curvature | Distance | Index | Number |
| S1 | First | 2.581 | 1.047 | 1.544 | 56.0 |
| S2 | Lens | 10.634 | 0.336 | | |
| S3 | Second | 15.861 | 0.206 | 1.680 | 18.2 |
| S4 | Lens | 5.615 | 0.208 | | |
| S5 | Third | 5.722 | 0.255 | 1.544 | 56.0 |
| S6 | Lens | 6.713 | 0.050 | | |
| S7 | Fourth | 6.513 | 0.290 | 1.544 | 56.0 |
| S8 | Lens | 15.421 | 0.438 | | |
| S9 | Fifth | 26.500 | 0.286 | 1.680 | 18.2 |
| S10 | Lens | 27.000 | 0.495 | | |
| S11 | Sixth | 7.937 | 0.327 | 1.567 | 37.4 |
| S12 | Lens | 7.841 | 0.322 | | |
| S13 | Seventh | 14.577 | 0.332 | 1.544 | 56.0 |
| S14 | Lens | −8.313 | 0.275 | | |
| S15 | Eighth | −7.343 | 0.385 | 1.567 | 37.4 |
| S16 | Lens | −7.154 | 0.322 | | |
| S17 | Ninth | 21.034 | 0.392 | 1.535 | 55.7 |
| S18 | Lens | 1.910 | 0.500 | | |
| S19 | Filter | Infinity | 0.110 | 1.517 | 64.2 |
| S20 | | Infinity | 0.470 | | |
| S21 | Imaging | Infinity | | | |
| | Plane | | | | |

In the ninth embodiment, the first lens 910 may have a positive refractive power, an object-side surface of the first lens 910 may be convex in a paraxial region thereof, and an image-side surface of the first lens 910 may be concave in a paraxial region thereof.

The second lens 920 may have a negative refractive power, an object-side surface of the second lens 920 may be convex in a paraxial region thereof, and an image-side surface of the second lens 920 may be concave in a paraxial region thereof.

The third lens 930 may have a positive refractive power, an object-side surface of the third lens 930 may be convex in a paraxial region thereof, and an image-side surface of the third lens 930 may be concave in a paraxial region thereof.

The fourth lens 940 may have a positive refractive power, an object-side surface of the fourth lens 940 may be convex in a paraxial region thereof, and an image-side surface of the fourth lens 940 may be concave in a paraxial region thereof.

The fifth lens 950 may have a positive refractive power, an object-side surface of the fifth lens 950 may be convex in a paraxial region thereof, and an image-side surface of the fifth lens 950 may be concave in a paraxial region thereof.

The sixth lens 960 may have a positive refractive power, an object-side surface of the sixth lens 960 may be convex in a paraxial region, thereof and an image-side surface of the sixth lens 960 may be concave in a paraxial region thereof.

The seventh lens 970 may have a positive refractive power, and an object-side surface and an image-side surface of the seventh lens 970 may be convex in respective paraxial regions thereof.

The eighth lens 980 may have a positive refractive power, an object-side surface of the eighth lens 980 may be concave in a paraxial region thereof, and an image-side surface of the eighth lens 980 may be convex in a paraxial region thereof.

The ninth lens 990 may have a negative refractive power, an object-side surface of the ninth lens 990 may be convex in a paraxial region thereof, and an image-side surface of the ninth lens 990 may be concave in a paraxial region thereof.

Also, any one or any combination of any two or more of the fifth lens 950, the sixth lens 960, the eighth lens 980, and the ninth lens 990 may have at least one inflection point on either one or both of the object-side surface and the image-side surface.

Each surface of each of the first lens 910 to the ninth lens 990 may have aspherical coefficients as listed in Table 18 below. For example, the object-side surface and the image-side surface of each of the first lens 910 to the ninth lens 990 may be aspherical.

TABLE 18

| | S1 | S2 | S3 | S4 | S5 | S6 |
|---|---|---|---|---|---|---|
| K | −1.977E+00 | −5.503E+01 | 5.151E+01 | 1.204E+01 | 7.843E+00 | −3.566E+00 |
| A | 1.445E−02 | −9.059E−03 | −7.311E−03 | −9.973E−04 | 9.046E−03 | 1.867E−02 |
| B | −1.707E−02 | 5.400E−02 | 3.167E−02 | −7.266E−02 | −1.191E−02 | 9.153E−03 |
| C | 5.178E−02 | −2.389E−01 | −1.537E−01 | 6.936E−01 | −3.740E−01 | −3.900E−01 |
| D | −1.057E−01 | 6.250E−01 | 4.433E−01 | −3.615E+00 | 2.389E+00 | 1.411E+00 |
| E | 1.421E−01 | −1.088E+00 | −8.095E−01 | 1.150E+01 | −7.850E+00 | −2.508E+00 |
| F | −1.299E−01 | 1.317E+00 | 1.008E+00 | −2.409E+01 | 1.646E+01 | 2.165E+00 |
| G | 8.235E−02 | −1.136E+00 | −8.794E−01 | 3.473E+01 | −2.362E+01 | 1.235E−01 |
| H | −3.652E−02 | 7.068E−01 | 5.407E−01 | −3.534E+01 | 2.388E+01 | −2.553E+00 |
| J | 1.128E−02 | −3.181E−01 | −2.312E−01 | 2.559E+01 | −1.718E+01 | 3.148E+00 |
| L | −2.379E−03 | 1.025E−01 | 6.620E−02 | −1.311E+01 | 8.748E+00 | −2.103E+00 |
| M | 3.261E−04 | −2.304E−02 | −1.163E−02 | 4.642E+00 | −3.078E+00 | 8.717E−01 |
| N | −2.615E−05 | 3.430E−03 | 9.680E−04 | −1.081E+00 | 7.118E−01 | −2.241E−01 |
| O | 9.250E−07 | −3.038E−04 | 1.462E−05 | 1.488E−01 | −9.730E−02 | 3.289E−02 |
| P | 6.893E−10 | 1.211E−05 | −6.270E−06 | −9.179E−03 | 5.955E−03 | −2.112E−03 |

| | S7 | S8 | S9 | S10 | S11 | S12 |
|---|---|---|---|---|---|---|
| K | −5.457E−01 | 8.933E+01 | 4.450E+01 | −2.746E+01 | −2.038E+01 | 2.937E+00 |
| A | 2.267E−02 | 1.196E−02 | −6.039E−02 | −5.126E−02 | −9.492E−02 | −1.131E−01 |
| B | −7.298E−02 | −1.559E−01 | 2.142E−01 | 5.469E−02 | 1.630E−01 | 1.032E−01 |
| C | 7.643E−02 | 8.038E−01 | −1.061E+00 | −1.654E−01 | −5.270E−01 | −2.905E−01 |
| D | 5.812E−02 | −2.804E+00 | 3.247E+00 | 3.136E−01 | 1.235E+00 | 6.232E−01 |
| E | −4.529E−01 | 6.723E+00 | −6.597E+00 | −3.220E−01 | −1.921E+00 | −8.301E−01 |
| F | 1.187E+00 | −1.146E+01 | 9.237E+00 | 5.174E−02 | 2.054E+00 | 7.300E−01 |
| G | −2.035E+00 | 1.422E+01 | −9.123E+00 | 3.149E−01 | −1.560E+00 | −4.454E−01 |
| H | 2.425E+00 | −1.297E+01 | 6.419E+00 | −4.679E−01 | 8.551E−01 | 1.934E−01 |
| J | −2.017E+00 | 8.687E+00 | −3.206E+00 | 3.583E−01 | −3.394E−01 | −6.022E−02 |
| L | 1.160E+00 | −4.215E+00 | 1.116E+00 | −1.728E−01 | 9.654E−02 | 1.334E−02 |
| M | −4.509E−01 | 1.440E+00 | −2.598E−01 | 5.437E−02 | −1.917E−02 | −2.047E−03 |
| N | 1.128E−01 | −3.275E−01 | 3.729E−02 | −1.088E−02 | 2.520E−03 | 2.067E−04 |
| O | −1.634E−02 | 4.450E−02 | −2.768E−03 | 1.262E−03 | −1.969E−04 | −1.233E−05 |
| P | 1.042E−03 | −2.728E−03 | 6.228E−05 | −6.472E−05 | 6.916E−06 | 3.289E−07 |

| | S13 | S14 | S15 | S16 | S17 | S18 |
|---|---|---|---|---|---|---|
| K | 5.417E+00 | 2.175E+00 | −1.605E−02 | −2.717E−01 | 1.225E+01 | −6.676E+00 |
| A | 7.168E−02 | 2.352E−01 | 2.591E−01 | 1.762E−01 | −1.858E−01 | −1.663E−01 |
| B | −2.454E−01 | −4.998E−01 | −5.324E−01 | −3.258E−01 | 8.388E−02 | 1.355E−01 |
| C | 3.013E−01 | 6.614E−01 | 6.865E−01 | 3.849E−01 | −6.037E−03 | −8.452E−02 |
| D | −1.983E−01 | −5.590E−01 | −5.843E−01 | −2.972E−01 | −1.292E−02 | 3.848E−02 |
| E | 6.554E−02 | 3.166E−01 | 3.352E−01 | 1.518E−01 | 7.440E−03 | −1.240E−02 |
| F | −6.729E−03 | −1.256E−01 | −1.336E−01 | −5.307E−02 | −2.169E−03 | 2.832E−03 |
| G | −3.980E−04 | 3.584E−02 | 3.789E−02 | 1.306E−02 | 4.033E−04 | −4.627E−04 |
| H | −1.658E−03 | −7.444E−03 | −7.753E−03 | −2.299E−03 | −5.129E−05 | 5.458E−05 |
| J | 1.361E−03 | 1.124E−03 | 1.148E−03 | 2.908E−04 | 4.576E−06 | −4.650E−06 |
| L | −4.776E−04 | −1.217E−04 | −1.218E−04 | −2.623E−05 | −2.868E−07 | 2.834E−07 |
| M | 9.532E−05 | 9.153E−06 | 9.026E−06 | 1.644E−06 | 1.238E−08 | −1.205E−08 |
| N | −1.130E−05 | −4.506E−07 | −4.436E−07 | −6.811E−08 | −3.502E−10 | 3.390E−10 |
| O | 7.438E−07 | 1.292E−08 | 1.298E−08 | 1.675E−09 | 5.846E−12 | −5.676E−12 |
| P | −2.104E−08 | −1.608E−10 | −1.713E−10 | −1.851E−11 | −4.358E−14 | 4.281E−14 |

The optical imaging system configured as described above may have the aberration properties illustrated in FIG. 18.

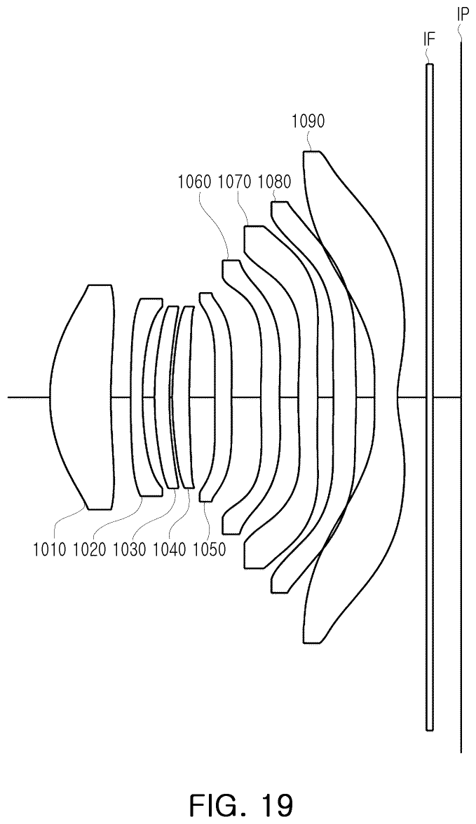

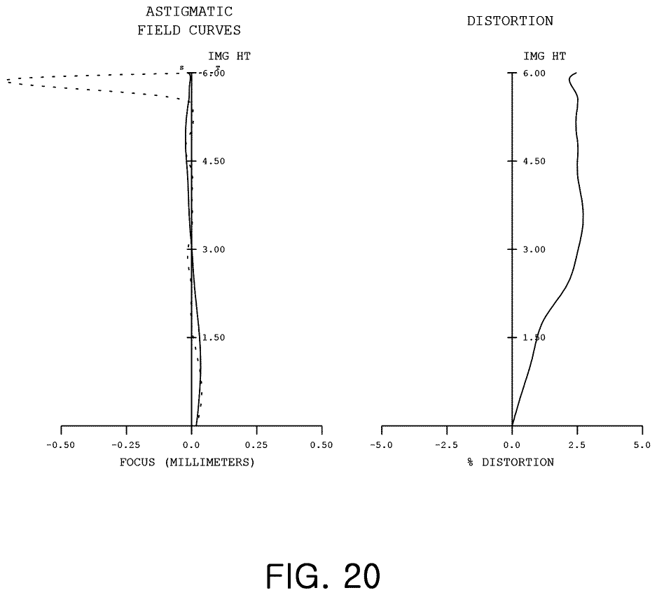

FIG. 19 is a configuration diagram illustrating an optical imaging system according to a tenth embodiment, and FIG. 20 is graphs illustrating aberration properties of the optical imaging system illustrated in FIG. 19.

Referring to FIG. 19, the optical imaging system according to the tenth embodiment may include a first lens 1010, a second lens 1020, a third lens 1030, a fourth lens 1040, a fifth lens 1050, a sixth lens 1060, a seventh lens 1070, an eighth lens 1080, and a ninth lens 1090 sequentially disposed in ascending numerical order along an optical axis of the optical imaging system from an object side of the optical imaging system toward an imaging plane IP of the optical imaging system, and may further include a filter IF disposed between the ninth lens 1090 and the imaging plane IP.

The optical imaging system according to the tenth embodiment may form a focus on the imaging plane IP. The imaging plane IP may be formed on an image sensor (not shown).

The characteristics (a radius of curvature, a thickness of an element or a distance between elements, a refractive index, and an Abbe number) of each element of the optical imaging system may be as listed in Table 19

TABLE 19

| Surface | | Radius of | Thickness or | Refractive | Abbe |
|---|---|---|---|---|---|
| No. | Element | Curvature | Distance | Index | Number |
| S1 | First | 2.581 | 1.047 | 1.544 | 56.0 |
| S2 | Lens | 10.683 | 0.337 | | |
| S3 | Second | 15.978 | 0.205 | 1.680 | 18.2 |
| S4 | Lens | 5.616 | 0.208 | | |
| S5 | Third | 5.723 | 0.254 | 1.544 | 56.0 |
| S6 | Lens | 6.671 | 0.050 | | |
| S7 | Fourth | 6.474 | 0.291 | 1.544 | 56.0 |
| S8 | Lens | 15.419 | 0.438 | | |
| S9 | Fifth | 26.303 | 0.287 | 1.680 | 18.2 |
| S10 | Lens | 27.764 | 0.499 | | |
| S11 | Sixth | 8.031 | 0.324 | 1.567 | 37.4 |
| S12 | Lens | 7.805 | 0.320 | | |
| S13 | Seventh | 14.471 | 0.334 | 1.544 | 56.0 |
| S14 | Lens | −8.313 | 0.271 | | |
| S15 | Eighth | −7.331 | 0.388 | 1.567 | 37.4 |
| S16 | Lens | −7.129 | 0.314 | | |
| S17 | Ninth | 21.039 | 0.394 | 1.535 | 55.7 |
| S18 | Lens | 1.912 | 0.500 | | |
| S19 | Filter | Infinity | 0.110 | 1.517 | 64.2 |
| S20 | | Infinity | 0.480 | | |
| S21 | Imaging | Infinity | | | |
| | Plane | | | | |

In the tenth embodiment, the first lens 1010 may have a positive refractive power, an object-side surface of the first lens 1010 may be convex in a paraxial region thereof, and an image-side surface of the first lens 1010 may be concave in a paraxial region thereof.

The second lens 1020 may have a negative refractive power, an object-side surface of the second lens 1020 may be convex in a paraxial region thereof, and an image-side surface of the second lens 1020 may be concave in a paraxial region thereof.

The third lens 1030 may have a positive refractive power, an object-side surface of the third lens 1030 may be convex in a paraxial region thereof, and an image-side surface of the third lens 1030 may be concave in a paraxial region thereof.

The fourth lens 1040 may have a positive refractive power, an object-side surface of the fourth lens 1040 may be convex in a paraxial region thereof, and an image-side surface of the fourth lens 1040 may be concave in a paraxial region thereof.

The fifth lens 1050 may have a positive refractive power, an object-side surface of the fifth lens 1050 may be convex in a paraxial region thereof, and an image-side surface of the fifth lens 1050 may be concave in a paraxial region thereof.

The sixth lens 1060 may have a negative refractive power, an object-side surface of the sixth lens 1060 may be convex in a paraxial region thereof, and an image-side surface of the sixth lens 1060 may be concave in a paraxial region thereof.

The seventh lens 1070 may have a positive refractive power, and an object-side surface and an image-side surface of the seventh lens 1070 may be convex in a paraxial regions thereof,

The eighth lens 1080 may have a positive refractive power, an object-side surface of the eighth lens 1080 may be concave in a paraxial region thereof, and an image-side surface of the eighth lens 1080 may be convex in a paraxial region thereof.

The ninth lens 1090 may have a negative refractive power, an object-side surface of the ninth lens 1090 may be convex in a paraxial region thereof, and an image-side surface of the ninth lens 1090 may be concave in a paraxial region thereof.

Also, any one or any combination of any two or more of the fifth lens 1050, the sixth lens 1060, the eighth lens 1080, and the ninth lens 1090 may have at least one inflection point on either one or both of the object-side surface and the image-side surface.

Each surface of each of the first lens 1010 to the ninth lens 1090 may have aspherical coefficients as listed in Table 20 below. For example, the object-side surface and the image-side surface of each of the first lens 1010 to the ninth lens 1090 may be aspherical.

TABLE 20

| | S1 | S2 | S3 | S4 | S5 | S6 |
|---|---|---|---|---|---|---|
| K | −1.978E+00 | −5.531E+01 | 5.194E+01 | 1.204E+01 | 7.841E+00 | −3.539E+00 |
| A | 1.458E−02 | −9.044E−03 | −7.312E−03 | −3.878E−04 | 8.898E−03 | 2.007E−02 |
| B | −1.786E−02 | 5.379E−02 | 3.334E−02 | −7.750E−02 | −1.004E−02 | −4.973E−03 |
| C | 5.445E−02 | −2.380E−01 | −1.635E−01 | 7.206E−01 | −3.811E−01 | −3.176E−01 |
| D | −1.113E−01 | 6.227E−01 | 4.731E−01 | −3.709E+00 | 2.400E+00 | 1.172E+00 |
| E | 1.501E−01 | −1.085E+00 | −8.680E−01 | 1.171E+01 | −7.837E+00 | −1.967E+00 |
| F | −1.380E−01 | 1.313E+00 | 1.086E+00 | −2.440E+01 | 1.636E+01 | 1.292E+00 |
| G | 8.814E−02 | −1.133E+00 | −9.536E−01 | 3.504E+01 | −2.340E+01 | 1.138E+00 |
| H | −3.955E−02 | 7.051E−01 | 5.911E−01 | −3.554E+01 | 2.359E+01 | −3.407E+00 |
| J | 1.244E−02 | −3.174E−01 | −2.559E−01 | 2.566E+01 | −1.694E+01 | 3.667E+00 |
| L | −2.693E−03 | 1.023E−01 | 7.487E−02 | −1.312E+01 | 8.607E+00 | −2.328E+00 |
| M | 3.856E−04 | −2.299E−02 | −1.376E−02 | 4.635E+00 | −3.023E+00 | 9.396E−01 |
| N | −3.355E−05 | 3.422E−03 | 1.316E−03 | −1.077E+00 | 6.982E−01 | −2.376E−01 |
| O | 1.469E−06 | −3.030E−04 | −1.942E−05 | 1.480E−01 | −9.531E−02 | 3.448E−02 |
| P | −1.706E−08 | 1.208E−05 | −4.754E−06 | −9.115E−03 | 5.827E−03 | −2.197E−03 |

| | S7 | S8 | S9 | S10 | S11 | S12 |
|---|---|---|---|---|---|---|
| K | −5.882E−01 | 8.931E+01 | 4.228E+01 | −1.310E+01 | −2.035E+01 | 2.943E+00 |
| A | 2.613E−02 | 1.159E−02 | −6.192E−02 | −5.069E−02 | −9.400E−02 | −1.127E−01 |
| B | −1.064E−01 | −1.533E−01 | 2.282E−01 | 5.208E−02 | 1.588E−01 | 1.024E−01 |
| C | 2.518E−01 | 7.924E−01 | −1.130E+00 | −1.480E−01 | −5.156E−01 | −2.895E−01 |
| D | −5.419E−01 | −2.784E+00 | 3.476E+00 | 2.510E−01 | 1.215E+00 | 6.215E−01 |
| E | 9.614E−01 | 6.728E+00 | −7.122E+00 | −1.857E−01 | −1.899E+00 | −8.278E−01 |
| F | −1.179E+00 | −1.156E+01 | 1.009E+01 | −1.450E−01 | 2.039E+00 | 7.278E−01 |
| G | 8.251E−01 | 1.444E+01 | −1.012E+01 | 5.124E−01 | −1.553E+00 | −4.440E−01 |
| H | −9.373E−02 | −1.325E+01 | 7.258E+00 | −6.092E−01 | 8.530E−01 | 1.928E−01 |
| J | −4.025E−01 | 8.919E+00 | −3.718E+00 | 4.307E−01 | −3.391E−01 | −6.004E−02 |
| L | 4.157E−01 | −4.344E+00 | 1.340E+00 | −1.992E−01 | 9.660E−02 | 1.330E−02 |
| M | −2.105E−01 | 1.488E+00 | −3.279E−01 | 6.107E−02 | −1.920E−02 | −2.042E−03 |
| N | 6.115E−02 | −3.392E−01 | 5.100E−02 | −1.200E−02 | 2.527E−03 | 2.062E−04 |
| O | −9.737E−03 | 4.615E−02 | −4.407E−03 | 1.373E−03 | −1.976E−04 | −1.230E−05 |
| P | 6.602E−04 | −2.832E−03 | 1.504E−04 | −6.965E−05 | 6.944E−06 | 3.282E−07 |

| | S13 | S14 | S15 | S16 | S17 | S18 |
|---|---|---|---|---|---|---|
| K | 5.339E+00 | 2.189E+00 | −3.322E−02 | −2.673E−01 | 1.236E+01 | −6.686E+00 |
| A | 7.116E−02 | 2.350E−01 | 2.593E−01 | 1.759E−01 | −1.856E−01 | −1.666E−01 |
| B | −2.429E−01 | −4.971E−01 | −5.329E−01 | −3.255E−01 | 8.252E−02 | 1.357E−01 |
| C | 2.969E−01 | 6.547E−01 | 6.873E−01 | 3.847E−01 | −4.187E−03 | −8.468E−02 |
| D | −1.962E−01 | −5.512E−01 | −5.850E−01 | −2.968E−01 | −1.419E−02 | 3.857E−02 |
| E | 6.746E−02 | 3.114E−01 | 3.357E−01 | 1.514E−01 | 7.967E−03 | −1.244E−02 |
| F | −1.013E−02 | −1.233E−01 | −1.338E−01 | −5.287E−02 | −2.314E−03 | 2.841E−03 |
| G | 1.975E−03 | 3.511E−02 | 3.796E−02 | 1.299E−02 | 4.310E−04 | −4.642E−04 |
| H | −2.668E−03 | −7.277E−03 | −7.769E−03 | −2.285E−03 | −5.505E−05 | 5.474E−05 |
| J | 1.651E−03 | 1.096E−03 | 1.150E−03 | 2.888E−04 | 4.939E−06 | −4.662E−06 |
| L | −5.354E−04 | −1.183E−04 | −1.221E−04 | −2.603E−05 | −3.117E−07 | 2.840E−07 |
| M | 1.033E−04 | 8.852E−06 | 9.048E−06 | 1.632E−06 | 1.356E−08 | −1.206E−08 |
| N | −1.203E−05 | −4.329E−07 | −4.447E−07 | −6.762E−08 | −3.874E−10 | 3.391E−10 |
| O | 7.837E−07 | 1.229E−08 | 1.302E−08 | 1.664E−09 | 6.541E−12 | −5.673E−12 |
| P | −2.203E−08 | −1.506E−10 | −1.718E−10 | −1.841E−11 | −4.942E−14 | 4.275E−14 |

The optical imaging system configured as described above may have the aberration properties illustrated in FIG. 20.

Table 21 below lists values of properties of the optical imaging systems according to the first embodiment to the tenth embodiment. In Table 21, f5 may be a focal length of the fifth lens, f6 may be a focal length of the sixth lens, f7 may be a focal length of the seventh lens, f8 may be a focal length of the eighth lens, and EPD may be an entrance pupil diameter of the optical imaging system.

TABLE 21

| Property | Emb. 1 | Emb. 2 | Emb. 3 | Emb. 4 | Emb. 5 |
|---|---|---|---|---|---|
| f | 6.347 | 6.424 | 6.350 | 6.405 | 6.415 |
| f1 | 28.903 | 31.056 | 24.642 | 24.364 | 24.303 |
| f2 | 6.475 | 6.247 | 6.661 | 6.616 | 6.594 |
| f3 | −9.232 | −8.843 | −9.002 | −8.819 | −8.752 |
| f4 | 16.554 | 14.418 | 14.463 | 18.029 | 20.477 |
| f5 | −48.513 | −29.496 | −29.734 | −162.100 | 136.692 |
| f6 | −73.178 | −34.836 | 62.575 | 57.374 | 59.761 |
| f7 | −64.373 | 74.515 | 209.012 | −274.809 | −64.767 |
| f8 | 8.063 | 8.287 | 11.263 | 12.958 | 12.656 |
| f9 | −5.169 | −4.601 | −4.444 | −4.766 | −4.946 |
| f12 | 5.525 | 5.430 | 5.475 | 5.427 | 5.408 |
| f123 | 10.610 | 10.665 | 10.645 | 10.711 | 10.754 |
| IMG HT | 6.000 | 6.000 | 6.000 | 6.000 | 6.000 |
| EPD | 3.981 | 4.029 | 3.986 | 4.021 | 4.027 |
| FOV | 85.3 | 85.0 | 85.2 | 85.0 | 85.0 |
| Fno | 1.594 | 1.594 | 1.593 | 1.593 | 1.593 |
| TTL | 7.459 | 7.500 | 7.467 | 7.500 | 7.500 |
| BFL | 0.899 | 0.911 | 0.884 | 0.924 | 0.925 |
| Yc92 | 1.362 | 1.249 | 1.340 | 1.347 | 1.281 |

| Property | Emb. 6 | Emb. 7 | Emb. 8 | Emb. 9 | Emb. 10 |
|---|---|---|---|---|---|
| f | 6.395 | 6.406 | 6.406 | 6.392 | 6.405 |
| f1 | 6.094 | 6.070 | 5.996 | 5.964 | 5.957 |
| f2 | −13.636 | −13.480 | −12.938 | −12.715 | −12.669 |
| f3 | 40.493 | 44.378 | 56.486 | 65.043 | 67.346 |
| f4 | 24.908 | 23.765 | 21.399 | 20.403 | 20.194 |
| f5 | −82.233 | −84.957 | −95.933 | 1683.229 | 671.666 |
| f6 | −511.003 | 425.059 | 104.751 | 4817.768 | −1008.496 |
| f7 | 8.348 | 8.689 | 9.966 | 9.740 | 9.714 |
| f8 | −99.459 | −97.293 | 377.002 | 279.837 | 267.371 |
| f9 | −3.774 | −3.933 | −4.031 | −3.939 | −3.944 |
| f12 | 9.278 | 9.269 | 9.316 | 9.327 | 9.330 |
| f123 | 7.826 | 7.922 | 8.195 | 8.320 | 8.350 |
| IMG HT | 6.000 | 6.000 | 6.000 | 6.000 | 6.000 |
| EPD | 3.784 | 3.790 | 3.790 | 3.782 | 3.789 |
| FOV | 85.0 | 85.0 | 85.0 | 85.1 | 85.0 |
| Fno | 1.690 | 1.690 | 1.690 | 1.690 | 1.690 |
| TTL | 7.050 | 7.050 | 7.050 | 7.045 | 7.050 |
| BFL | 0.989 | 1.019 | 1.078 | 1.080 | 1.090 |
| Yc92 | 1.312 | 1.274 | 1.215 | 1.225 | 1.221 |

Table 22 below lists values of Conditional Expressions 1 to 23 of the optical imaging systems according to the first embodiment to the tenth embodiment.

TABLE 22

| Conditional Expression | Emb. 1 | Emb. 2 | Emb. 3 | Emb. 4 | Emb. 5 |
|---|---|---|---|---|---|
| (TTL/(2 × IMG HT)) × Fno | 0.991 | 0.996 | 0.991 | 0.996 | 0.996 |
| f1/f | 4.554 | 4.834 | 3.881 | 3.804 | 3.788 |
| \|f2/f\| | 1.020 | 0.972 | 1.049 | 1.033 | 1.028 |
| \|f3/f\| | 1.455 | 1.377 | 1.418 | 1.377 | 1.364 |
| f4/f | 2.608 | 2.244 | 2.278 | 2.815 | 3.192 |
| f9/f | −0.814 | −0.716 | −0.700 | −0.744 | −0.771 |
| f12/f | 0.870 | 0.845 | 0.862 | 0.847 | 0.843 |
| \|f12/f3 | 0.598 | 0.614 | 0.608 | 0.615 | 0.618 |
| f123/f | 1.672 | 1.660 | 1.676 | 1.672 | 1.676 |
| TTL/f | 1.175 | 1.167 | 1.176 | 1.171 | 1.169 |
| TTL/BFL | 8.297 | 8.233 | 8.447 | 8.117 | 8.108 |
| ΣCT | 3.688 | 3.725 | 3.718 | 3.709 | 3.723 |
| ΣAT | 2.872 | 2.863 | 2.866 | 2.868 | 2.854 |
| ΣCT/ΣAT | 1.284 | 1.301 | 1.297 | 1.293 | 1.304 |
| Td | 6.560 | 6.588 | 6.584 | 6.577 | 6.577 |
| Td/f | 1.034 | 1.026 | 1.037 | 1.027 | 1.025 |
| Yc92/f | 0.215 | 0.194 | 0.211 | 0.210 | 0.200 |
| FOV × (IMG HT/f) | 80.637 | 79.390 | 80.504 | 79.625 | 79.501 |
| TTL/(2 × IMG HT) | 0.622 | 0.625 | 0.622 | 0.625 | 0.625 |
| Fno | 1.594 | 1.594 | 1.593 | 1.593 | 1.593 |
| v6 − v5 | 36.8 | 36.8 | 36.8 | 36.8 | 36.8 |
| \|v6 − v7\| | 30.1 | 30.1 | 30.1 | 30.1 | 30.1 |
| T14/TTL | 0.240 | 0.242 | 0.246 | 0.241 | 0.240 |

| Conditional Expression | Emb. 6 | Emb. 7 | Emb. 8 | Emb. 9 | Emb. 10 |
|---|---|---|---|---|---|
| (TTL/(2 × IMG HT)) × Fno | 0.993 | 0.993 | 0.993 | 0.992 | 0.993 |
| f1/f | 0.953 | 0.948 | 0.936 | 0.933 | 0.930 |
| \|f2/f\| | 2.132 | 2.104 | 2.020 | 1.989 | 1.978 |
| \|f3/f\| | 6.332 | 6.928 | 8.818 | 10.176 | 10.515 |
| f4/f | 3.895 | 3.710 | 3.340 | 3.192 | 3.153 |
| f9/f | −0.590 | −0.614 | −0.629 | −0.616 | −0.616 |
| f12/f | 1.451 | 1.447 | 1.454 | 1.459 | 1.457 |
| \|f12/f3\| | 0.229 | 0.209 | 0.165 | 0.143 | 0.139 |
| f123/f | 1.224 | 1.237 | 1.279 | 1.302 | 1.304 |
| TTL/f | 1.102 | 1.101 | 1.101 | 1.102 | 1.101 |
| TTL/BFL | 7.128 | 6.919 | 6.540 | 6.523 | 6.468 |
| ΣCT | 3.511 | 3.519 | 3.482 | 3.520 | 3.524 |
| ΣAT | 2.552 | 2.514 | 2.489 | 2.446 | 2.437 |
| ΣCT/ΣAT | 1.376 | 1.400 | 1.399 | 1.439 | 1.446 |
| Td | 6.063 | 6.033 | 5.971 | 5.966 | 5.961 |
| Td/f | 0.948 | 0.942 | 0.932 | 0.933 | 0.931 |
| Yc92/f | 0.205 | 0.199 | 0.190 | 0.192 | 0.191 |
| FOV × (IMG HT/f) | 79.750 | 79.613 | 79.613 | 79.881 | 79.625 |
| TTL/(2 × IMG HT) | 0.588 | 0.588 | 0.588 | 0.587 | 0.588 |
| Fno | 1.690 | 1.690 | 1.690 | 1.690 | 1.690 |
| v6 − v5 | 19.2 | 19.2 | 19.2 | 19.2 | 19.2 |
| \|v6 − v7\| | 18.6 | 18.6 | 18.6 | 18.6 | 18.6 |
| T14/TTL | 0.297 | 0.299 | 0.298 | 0.298 | 0.298 |

According to the aforementioned embodiments, an optical imaging system may have a reduced size and a high resolution.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having a positive refractive power;
a second lens having a refractive power;
a third lens having a refractive power;
a fourth lens having a positive refractive power;
a fifth lens having a refractive power;
a sixth lens having a refractive power;
a seventh lens having a refractive power;
an eighth lens having a refractive power; and
a ninth lens having a negative refractive power,
wherein the first to ninth lenses are sequentially disposed in ascending numerical order along an optical axis of the optical imaging system from an object side of the optical imaging system toward an imaging plane of the optical imaging system, and
0.90<(TTL/(2×IMG HT))×Fno<1.00 and 1.00<f4/f<4.00 are satisfied, where TTL is a distance along the optical axis from an object-side surface of the first lens to the imaging plane, IMG HT is one half of a diagonal length of the imaging plane, Fno is an F-number of the optical imaging system, f4 is a focal length of the fourth lens, and f is a focal length of the optical imaging system.

2. The optical imaging system of claim 1, wherein, among the second lens and the third lens, a lens having negative refractive power has a refractive index of 1.63 or more.

3. The optical imaging system of claim 1, wherein a combined focal length of the second lens and the third lens has a positive value.

4. The optical imaging system of claim 1, wherein a combined focal length of the first lens to the third lens has a positive value.

5. The optical imaging system of claim 1, wherein 0<f1/f<5.00 is satisfied, where f1 is a focal length of the first lens.

6. The optical imaging system of claim 1, wherein 0.80<|f2/f|<2.20 is satisfied, where f2 is a focal length of the second lens.

7. The optical imaging system of claim 1, wherein 0.80<f12/f<1.50 is satisfied, where f12 is a combined focal length of the first lens and the second lens.

8. The optical imaging system of claim 1, wherein 0.10<|f12/f3|<0.70 is satisfied, where f12 is a combined focal length of the first lens and the second lens, and f3 is a focal length of the third lens.

9. The optical imaging system of claim 1, wherein 1.10<f123/f<1.70 is satisfied, where f123 is a combined focal length of the first lens, the second lens, and the third lens.

10. The optical imaging system of claim 1, wherein −0.82<f9/f<0 is satisfied, where f9 is a focal length of the ninth lens.

11. The optical imaging system of claim 1, wherein 75°<FOV×(IMG HT/f)<82° and 0.55<TTL/(2×IMG HT)<0.65 are satisfied, where FOV is a field of view of the optical imaging system.

12. The optical imaging system of claim 1, wherein 1.00<ΣCT/ΣAT<2.00 is satisfied, where ΣCT is a sum of thicknesses along the optical axis of the first lens to the ninth lens, and ΣAT is a sum of air gaps between adjacent lenses of the first lens to the ninth lens.

13. The optical imaging system of claim 1, wherein 0.90<Td/f<1.50 is satisfied, where Td is a distance along the optical axis from the object-side surface of the first lens to an image-side surface of the ninth lens.

14. The optical imaging system of claim 1, wherein 0.15<Yc92/f<0.50 is satisfied, where Yc92 is a distance from the optical axis to an inflection point of an image-side surface of the ninth lens in a direction perpendicular to the optical axis.

15. The optical imaging system of claim 1, wherein the object-side surface of the first lens is convex in a paraxial region thereof, and an image-side surface of the third lens is concave in a paraxial region thereof.

16. The optical imaging system of claim 15, wherein an object-side surface of each of the fourth lens to the sixth lens is convex, and an image-side surface of each of the fourth lens to the sixth lens is concave.

17. The optical imaging system of claim 1, wherein 1.00<|f3/f|<15.00 is satisfied, where f3 is a focal length of the third lens.

18. The optical imaging system of claim 1, wherein 5.00<TTL/BFL<10 is satisfied, where BFL is a distance along the optical axis from an image-side surface of the ninth lens to the imaging plane.

19. The optical imaging system of claim 1, wherein 1.55<Fno<1.75 is satisfied.

20. The optical imaging system of claim 1, wherein 0.20<T14/TTL<0.31 is satisfied, where T14 is a distance along the optical axis from the object-side surface of the first lens to an object-side surface of the fourth lens.
